(19) United States
(12) Patent Application Publication
(10) Pub. No.: US 2025/0202160 A1
(43) Pub. Date: Jun. 19, 2025

(54) ELECTRONIC DEVICE COMPRISING CONNECTOR

(71) Applicant: SAMSUNG ELECTRONICS CO., LTD., Suwon-si (KR)

(72) Inventors: Seonkyu KIM, Suwon-si (KR); Kyungsup LEE, Suwon-si (KR); Myunghoon KWAK, Suwon-si (KR); Sungkwang YANG, Suwon-si (KR); Hyunmo YANG, Suwon-si (KR); Choongho ZEE, Suwon-si (KR); Nakhyun CHOI, Suwon-si (KR)

(21) Appl. No.: 19/072,748

(22) Filed: Mar. 6, 2025

Related U.S. Application Data
(63) Continuation of application No. PCT/KR2024/002721, filed on Mar. 4, 2024.

(30) Foreign Application Priority Data
Apr. 25, 2023 (KR) 10-2023-0053937
May 25, 2023 (KR) 10-2023-0067688

(51) Int. Cl. H01R 13/62; H01R 13/52; H01R 13/645

(52) U.S. Cl. CPC H01R 13/6205; H01R 13/645; H01R 13/5219

(57) ABSTRACT

An electronic device includes a first connector including a first housing including a first surface, a plurality of first terminals provided on the first surface, a first magnetic body enclosing the plurality of first terminals, and a first barrier enclosing an inner side surface of the first magnetic body, and a second connector that is connectable to the first connector and includes a second housing including a second surface, a plurality of second terminals provided on the second surface, a second magnetic body attachable to and detachable from the first magnetic body and enclosing the plurality of second terminals, and a second barrier enclosing an inner side surface of the second magnetic body.

### CROSS-REFERENCE TO RELATED APPLICATIONS

This application is a continuation application of International Application No. PCT/KR2024/002721 designating the United States, filed on Mar. 4, 2024, in the Korean Intellectual Property Receiving Office and claiming priority to Korean Patent Application No. 10-2023-0067688, filed on May 25, 2023, and Korean Patent Application No. 10-2023-0053937, filed on Apr. 25, 2023, in the Korean Intellectual Property Office, the disclosures of which are incorporated by reference herein in their entireties.

### BACKGROUND

### 1. Field

The disclosure relates to an electronic device including a connector.

### 2. Description of Related Art

With technological advancements, various types of electronic devices have been developed, and these electronic devices are used in various ways according to the use environment of a user. Examples of electronic devices are not limited to a portable communication device, such as a smartphone, a tabletop personal computer (PC), or a laptop, but also a wearable device, such as a smartwatch or a head-mounted display (HMD).

As an example of an electronic device, a wearable device may be worn on the body of the user and may provide various pieces of information by generating and displaying a virtual image in front of the user through a display panel. For example, the wearable device may provide virtual reality (VR), mixed reality (MR), or extended reality (XR) experiences to the user. The wearable device may be used in various industrial fields.

The electronic device may include a connector that is connectable to a counterpart connector, such as a charging connector or a communication connector, to receive power through the connector or to transmit and receive data with an external electronic device.

However, the foregoing description should not be construed as having been acknowledged by the applicant as a prior art to the description set forth in the disclosure but should be construed only as a related art to the invention described herein.

### SUMMARY

According to an embodiment, an electronic device for protecting a terminal, preventing an inflow of a foreign substance around a magnetic body or a terminal, improving a coupling force between a connector and a counterpart connector, or providing coupling convenience of a connector may be provided.

The technical goals to be achieved through example embodiments of the present disclosure are not limited to those described above, and other technical goals not mentioned above are clearly understood by one of ordinary skill in the art from the following description.

According to one embodiment, an electronic device includes a first connector including a first housing including a first surface, a plurality of first terminals provided on the first surface, a first magnetic body enclosing the plurality of first terminals, and a first barrier enclosing an inner side surface of the first magnetic body, and a second connector that is connectable to the first connector and includes a second housing including a second surface, a plurality of second terminals provided on the second surface, a second magnetic body attachable to and detachable from the first magnetic body and enclosing the plurality of second terminals, and a second barrier enclosing an inner side surface of the second magnetic body. In an embodiment, in at least a partial area, the first barrier extends higher than the first magnetic body from the first surface. In an embodiment, in at least a partial area, the second barrier extends higher than the second magnetic body from the second surface.

Alternatively, an electronic device according to an embodiment includes a first housing including a first surface, a plurality of first terminals provided on the first surface, a first magnetic body enclosing the plurality of first terminals, and a first barrier enclosing an inner side surface of the first magnetic body. In an embodiment, the first barrier may extend higher than the first magnetic body from the first surface in at least a partial area.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram of an electronic device in a network environment according to one embodiment;

FIG. 2A is a perspective view of a front surface of a wearable device according to an embodiment;

FIG. 2B is a perspective view of a rear surface of a wearable device according to an embodiment;

FIG. 3A is a perspective view of a first connector of an electronic device according to an embodiment;

FIG. 3B is a perspective view of a second connector of an electronic device according to an embodiment;

FIG. 3C is a perspective view of a combination relationship of a first connector and a second connector of an electronic device according to an embodiment;

FIG. 4A is a cross-sectional view of a first connector according to an embodiment;

FIG. 4B is a cross-sectional view of a second connector according to an embodiment;

FIG. 5A is a cross-sectional view of a first connector according to an embodiment;

FIG. 5B is a cross-sectional view of a second connector according to an embodiment;

FIG. 6A is a cross-sectional view of a first connector according to an embodiment;

FIG. 6B is a cross-sectional view of a second connector according to an embodiment;

FIG. 7A is a cross-sectional view of a first connector according to an embodiment;

FIG. 7B is a cross-sectional view of a second connector according to an embodiment;

FIG. 8A is a cross-sectional view of a first connector according to an embodiment;

FIG. 8B is a cross-sectional view of a second connector according to an embodiment;

FIG. 8C is a cross-sectional view of a combination state of a first connector and a second connector according to an embodiment;

FIG. 8D is a cross-sectional view of a state in which a first connector and a second connector face each other according to an embodiment;

FIG. 9A is a cross-sectional view of a first connector according to an embodiment;

FIG. 9B is a cross-sectional view of a second connector according to an embodiment;

FIG. 10A is a cross-sectional view of a first connector according to an embodiment; and

FIG. 10B is a cross-sectional view of a second connector according to an embodiment.

### DETAILED DESCRIPTION

Hereinafter, embodiments will be described in detail with reference to the accompanying drawings. When describing the embodiments with reference to the accompanying drawings, like reference numerals refer to like elements and a repeated description related thereto will be omitted.

It should be appreciated that embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via a third element.

As used in connection with embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to one embodiment, the module may be implemented in a form of an application-specific integrated circuit (ASIC).

Embodiments of the present disclosure as set forth herein may be implemented as software (e.g., the program 120) including one or more instructions that are stored in a storage medium (e.g., an internal memory 136 or an external memory 138) that is readable by a machine (e.g., an electronic device). For example, a processor of the machine (e.g., an electronic device) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method according to one embodiment of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to embodiments, one or more of the above-described components may be omitted, or one or more other components may be added. Alternatively or additionally, a plurality of components (e.g., modules or programs) may be integrated into a single component. In such a case, according to various example embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

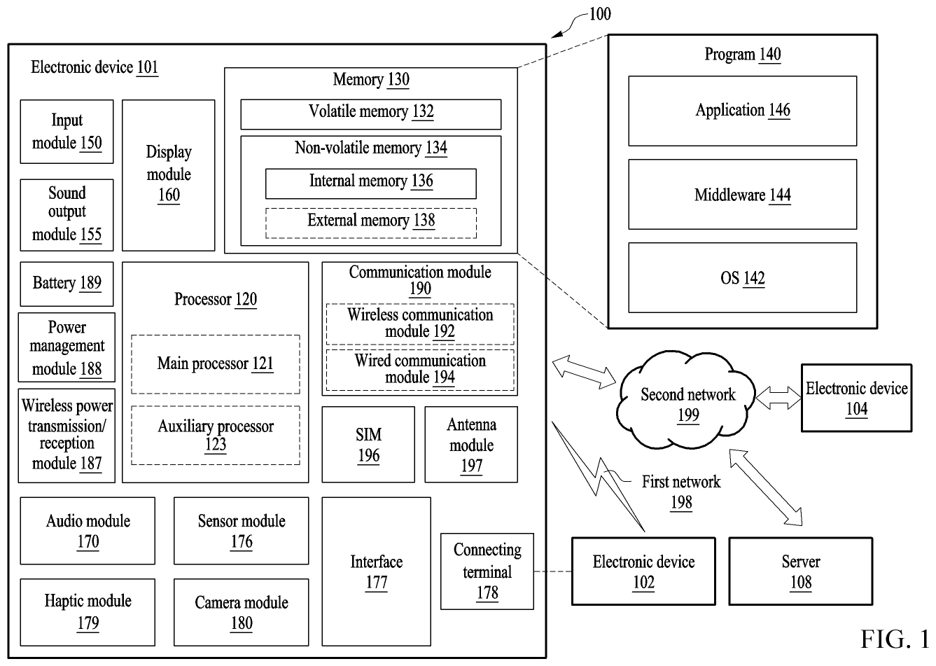

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to one embodiment, the electronic device 101 may communicate with the electronic device 104 via the server 108. According to one embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one (e.g., the connecting terminal 178) of the above components may be omitted from the electronic device 101, or one or more other components may be added in the electronic device 101. In some embodiments, some (e.g., the sensor module 176, the camera module 180, or the antenna module 197) of the components may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to one embodiment, as at least a portion of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to one embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is in an active state (e.g., executing an application). According to one embodiment, the auxiliary processor 123 (e.g., an ISP or a CP) may be implemented as a portion of another component (e.g., the camera module 180 or the communication module 190) that is functionally related to the auxiliary processor 123. According to one embodiment, the auxiliary processor 123 (e.g., an NPU) may include a hardware structure specified for artificial intelligence (AI) model processing. An AI model may be generated by machine learning. Such learning may be performed by, for example, the electronic device 101 in which artificial intelligence is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may additionally or alternatively include a software structure other than the hardware structure.

The memory 130 may store various data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used to receive an incoming call. According to one embodiment, the receiver may be implemented separately from the speaker or as a part of the speaker.

The display module 160 may visually provide information to the outside (e.g., a user) of the electronic device 101. The display module 160 may include, for example, a control circuit for controlling a display, a hologram device, or a projector and control circuitry to control a corresponding one of the display, the hologram device, and the projector. According to one embodiment, the display module 160 may include a touch sensor adapted to sense a touch, or a pressure sensor adapted to measure an intensity of a force incurred by the touch.

The audio module 170 may convert a sound into an electric signal or vice versa. According to one embodiment, the audio module 170 may obtain the sound via the input module 150 or output the sound via the sound output module 155 or an external electronic device (e.g., an electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101, and generate an electrical signal or data value corresponding to the detected state. According to one embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to one embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a part of a power management integrated circuit (PMIC). The wireless power transmission/reception module 187 may be configured to transmit and receive power wirelessly.

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently of the processor 120 (e.g., an AP) and that support a direct (e.g., wired) communication or a wireless communication. According to one embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN))). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to one embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. According to an embodiment, the antenna module 197 may include an antenna including a radiating element including a conductive material or a conductive pattern formed in or on a substrate (e.g., a printed circuit board (PCB)). According to one embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to one embodiment, another component (e.g., a radio frequency integrated circuit (RFIC)) other than the radiating element may be additionally formed as a part of the antenna module 197.

According to one embodiment, the antenna module 197 may form a mmWave antenna module. According to one embodiment, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to one embodiment, commands or data may be transmitted or received between the electronic device 101 and the external electronic device 104 via the server 108 coupled with the second network 199. Each of the external electronic devices 102 and 104 may be a device of the same type as or a different type from the electronic device 101. According to one embodiment, all or some of operations to be executed by the electronic device 101 may be executed at one or more of the external electronic devices 102, 104, and 108. For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the result, with or without further processing the result, as at least part of a response to the request. To this end, cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to one embodiment, the external electronic device 104 or the server 108 may be included in the second network 199. The electronic device 101 may be applied to intelligent services (e.g., a smart home, a smart city, a smart car, or healthcare) based on 5G communication technology or IoT-related technology.

In an embodiment, each of the external electronic devices 102 and 104 may be a device of the same type as or a different type from the electronic device 101. According to an embodiment, all or some of operations to be executed by the electronic device 101 may be executed at one or more of the external electronic devices and the server 102, 104, or 108. For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the result, with or without further processing the result, as at least part of a response to the request.

For example, after rendering content data executed by an application, the external electronic device 102 may transmit the content data to the electronic device 101 and the electronic device 101 receiving the data may output the content data to the display module 160. When the electronic device 101 detects a movement of a user through an inertial measurement unit (IMU) sensor or the like, the processor 120 of the electronic device 101 may correct the rendering data received from the external electronic device 102 based on the movement information and output the corrected movement information to the display module 160. Alternatively, the processor 120 may transmit the information on the motion to the external electronic device 102 and request the rendering such that screen data may be updated according to the information. According to one embodiment, the external electronic device 102 may be a device in various forms, such as a smartphone or a case device for storing and charging the electronic device 101.

The electronic device according to embodiments may be one of various types of electronic devices. The electronic device may include, for example, a portable communication device (e.g., a smartphone), a computer device, a portable multimedia device, a portable medical device, a camera, a wearable device, or a home appliance device. According to an embodiment of the present disclosure, the electronic device is not limited to those described above.

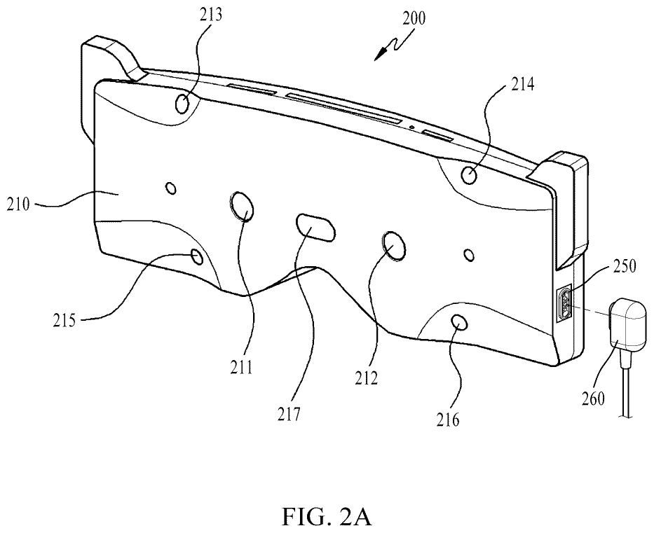

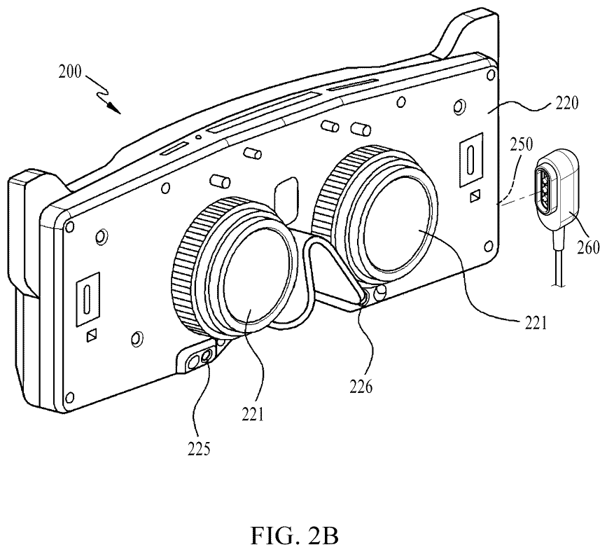

FIGS. 2A and 2B are perspective views of a front surface and a rear surface of a wearable device 200 according to an embodiment.

Referring to FIGS. 2A and 2B, the wearable device 200 (e.g., the electronic device 101 or the electronic device 102) may be worn on the body, for example, the head, of a user.

In an embodiment, the wearable device 200 may output an image and/or a video to the user. Alternatively, the wearable device 200 may provide an image related to an augmented reality (AR) service and/or a virtual reality (VR) service.

For example, the wearable device 200 may provide AR to the user. The wearable device 200 may transmit a virtual object image output from a display 221 (e.g., the display module 160 of FIG. 1) to an eye of the user and the virtual object image may utilize data on an image of the real world captured through a plurality of camera modules 211, 212, 213, 214, 215, and 216.

In an embodiment, the wearable device 200 may be, for example, a head-mounted display (HMD) or a face-mounted display (FMD). Alternatively, the wearable device 200 may be smart glasses or a smart headset for providing extended reality, such as AR, VR, or mixed reality, but is not limited thereto.

In an embodiment, at least one of the plurality of camera modules 211, 212, 213, 214, 215, and 216 and/or a depth sensor 217 for obtaining information related to a surrounding environment of the wearable device 200 (e.g., the electronic device 101 of FIG. 1) may be disposed on a first surface 210 of a housing.

In an embodiment, the camera modules 211 and 212 of the plurality of camera modules 211, 212, 213, 214, 215, and 216 may obtain an image related to the surrounding environment of the wearable device 200. In addition, the camera modules 213, 214, 215, and 216 of the plurality of camera modules 211, 212, 213, 214, 215, and 216 may obtain an image while the wearable device 200 is worn by the user. The camera modules 213, 214, 215, and 216 of the plurality of camera modules 211, 212, 213, 214, 215, and 216 may be used for hand detection, tracking, and recognition of a gesture (e.g., a hand gesture) of a user. The camera modules 213, 214, 215, and 216 of the plurality of camera modules 211, 212, 213, 214, 215, and 216 may be used for 3 degrees of freedom (DoF) and 6DoF head tracking, recognition of a position (space and environment), and/or recognition of a movement. According to an embodiment, the camera modules 211 and 212 of the plurality of camera modules 211, 212, 213, 214, 215, and 216 may be used for hand detection, tracking, and recognition of a gesture of the user.

According to an embodiment, the depth sensor 217 may be configured to transmit a signal and receive a signal reflected from an object and may be used to identify a distance to the object, for example, time of flight (TOF). Instead of or in addition to the depth sensor 217, the camera modules 213, 214, 215, and 216 of the plurality of camera modules 211, 212, 213, 214, 215, and 216 may determine a distance from an object.

In an embodiment, at least one of the plurality of camera modules 211, 212, 213, 214, 215, and 216 may include a camera for 3DoF or 6DoF head tracking, hand detection and tracking, and gesture and/or space recognition.

In an embodiment, at least one of the plurality of camera modules 211, 212, 213, 214, 215, and 216 may include a global shutter (GS) camera for detecting a motion of the head or hand and tracking the motion. For example, a stereo camera may be used for head tracking and space recognition, and accordingly, two GS cameras with the same standard and performance may be used. A rolling shutter (RS) camera may be used to detect quick hand movement and minute movement of a finger and track movement thereof.

In an embodiment, in at least one of the plurality of camera modules 211, 212, 213, 214, 215, and 216, a GS camera with excellent camera performance (e.g., image blur) may be mainly used. However, the example is not limited thereto and for example, an RS camera may be used. At least one of the plurality of camera modules 211, 212, 213, 214, 215, and 216 may perform a simultaneous localization and mapping (SLAM) function through spatial recognition and depth capturing for 6DoF. Alternatively, at least one of a plurality of cameras may perform a user gesture recognition function.

According to an embodiment, camera modules 225 and 226 for face recognition and/or the display 221 (and/or a lens) may be disposed on the second surface 220.

In an embodiment, the camera modules 225 and 226 for face recognition adjacent to the display 221 may be used to recognize a face of a user or to track the eyes of the user.

In an embodiment, the display 221 (and/or a lens) may be disposed on the second surface 220 of the wearable device 200. In an embodiment, the wearable device 200 may not include the camera modules 215 and 216 of the plurality of camera modules 213, 214, 215, and 216.

In an embodiment, the display 221 may include, for example, a liquid crystal display (LCD), a digital mirror device (DMD), or a liquid crystal on silicon (LCoS), a light-emitting diode on silicon (LEDoS), an organic light-emitting diode (OLED), a micro light-emitting diode (micro LED), or the like.

Although not shown in the drawings, when the display 221 is one of an LCD, a DMD, and an LCOS, the wearable device 200 may include a light source configured to emit light to a screen output area of the display 221.

In an embodiment, when the display 221 is capable of generating light by itself, for example, when the display 221 is either an OLED or a micro-LED, the wearable device 200 may provide a virtual image of decent quality to the user even though a separate light source is not included.

The display 221 according to an emitting may include OLEDs. For example, an OLED may express red (R), green (G), and blue (B) through self-luminescence of an organic material. However, the example is not limited thereto. A single pixel may include R, G, and B and a single chip may be implemented by a plurality of pixels including R, G, and B.

In an embodiment, the display 221 may display various images. In this case, the image may include a still image and a moving image and the display 221 may display various images, such as broadcast content and multimedia content. Further, the display 221 may display a user interface (UI) and an icon.

In an embodiment, the display 221 may include a separate integrated circuit (IC) chip and the IC chip may display an image based on an image signal received from a processor (e.g., the processor 120 of FIG. 1). In an embodiment, the IC chip may display an image by generating driving signals of a plurality of light emitting devices based on the image signal received from the processor 120 and controlling light emitted from a plurality of pixels included in a display panel based on the driving signals.

In an embodiment, the display 221 may include a plurality of pixels for displaying a virtual image. In an embodiment, the display 221 may further include infrared pixels that emit infrared light.

In an embodiment, the display 221 may further include a light-receiving pixel (e.g., a photo sensor pixel) disposed between pixels and configured to receive light reflected on the eyes of a user, convert the received light into electrical energy, and output the electrical energy. The light-receiving pixel may be referred to as a “gaze tracking sensor”. The gaze tracking sensor may sense infrared light which is emitted by an infrared pixel included in the display 221 and is reflected by the eyes of the user.

In an embodiment, when the display 221 is implemented as an OLED or a micro-LED, a light source may be unnecessary, and accordingly the wearable device 200 may be lightened. The wearable device 200 may include the display 221, a first transparent member, and/or a second transparent member. A user may use the wearable device 200 while wearing the wearable device 200 on their face. The first transparent member and/or the second transparent member may be formed of a glass plate, a plastic plate, or a polymer, and may be transparently or translucently formed.

According to an embodiment, the first transparent member may be disposed to face the right eye of the user, and the second transparent member may be disposed to face the left eye of the user. According to various embodiments, when the display 221 is transparent, the display 221 may be disposed to face the eyes of the user to configure a screen display portion.

According to an embodiment, a lens may serve to adjust a focus such that a screen output to the display is visible to the eyes of the user. For example, the lens may include a Fresnel lens, a pancake lens, or a multi-channel lens.

In an embodiment, the wearable device 200 may be connected to a counterpart connector 260 via a connector 250. For example, the counterpart connector 260 may be a charging cable, a communication cable, and/or charging-communication cable, and is not limited thereto. The counterpart connector 260 may be a component of an accessory device or an auxiliary device connectable to the wearable device 200.

In an embodiment, the counterpart connector 260 may be a cable including a metal pin to be electrically connected to the wearable device 200 by being coupled to the connector 250 of the wearable device 200. The counterpart connector 260 may be easily and stably attached to and detached from the wearable device 200 by structurally and/or electromagnetically linking with the connector 250.

For example, the counterpart connector 260 may be a cable including a pogo pin. Alternatively, the counterpart connector 260 may include a contact terminal including a leaf spring, such as a c-clip, or an elastic body, such as a pogo pin. The counterpart connector 260 may be attached to and detached from the wearable device 200 by structurally linking with the contact terminal of the connector 250 of the wearable device 200.

For example, the counterpart connector 260 may be a cable including a magnetic body. Alternatively, the counterpart connector 260 may include a contact terminal including a magnetic body, an electromagnetic structure, or a metallic material. The counterpart connector 260 may be attached to and detached from the wearable device 200 by electromagnetically linking with the contact terminal of the connector 250 of the wearable device 200.

In an embodiment, the connector 250 may be a connecting unit (e.g., the connecting terminal 178 of FIG. 1) to be connected to the counterpart connector 260. Through the connector 250, the wearable device 200 may receive power from the outside or may be electrically connected to an external device (e.g., the electronic device 102 of FIG. 1). The connector 250 may be connected to a battery (not shown) and/or a processor (not shown) of the wearable device 200.

In an embodiment, the connector 250 may be provided in the housing. For example, as shown in FIGS. 2A and 2B, the connector 250 may be provided on one side of the housing.

In an embodiment, the counterpart connector 260 may be a component of the wearable device 200 and may be attached to and detached from the connector 250. For example, the counterpart connector 260 may be distributed, sold, and/or used with other components of the wearable device 200.

In an embodiment, the counterpart connector 260 may be a separate external component from the wearable device 200. For example, the counterpart connector 260 may be distributed, sold, and/or used separately from the wearable device 200. The counterpart connector 260 may be a connecting device that is compatible with the wearable device 200.

Hereinafter, the counterpart connector 260 is described as a component of the wearable device 200 as an example, but in the actual implementation, the example is not limited thereto. For example, the counterpart connector 260 that is connectable to the wearable device 200 may be replaced with another compatible external device (not shown).

As described above, the wearable device 200 according to an embodiment may have a form factor to be worn on a head of a user. The wearable device 200 may further include a wearing member and/or a strap to be fixed onto a body part of the user. The wearable device 200 may provide a user experience based on an AR, a VR, and/or an MR in a state of being worn on the head of the user.

In an embodiment, although not shown in the drawings, the wearable device 200 may include at least a portion of a sensor (not shown), a lighting unit (not shown), a plurality of microphones (not shown), a plurality of speakers (not shown), a battery (not shown), and a PCB (not shown).

In an embodiment, one or more sensors (not shown) may be provided for various purposes (e.g., a gyro sensor, an acceleration sensor, a geomagnetic sensor, and/or a gesture sensor), and for example, the sensor (not shown) may perform at least one of head tracking for 6DoF, pose estimation and prediction, gesture and/or spatial recognition, and/or a SLAM function through depth capturing.

In an embodiment, the lighting unit (not shown) may be used differently depending on a position in which the lighting unit is attached. The lighting unit (not shown) may use an IR LED device with a visible light wavelength or an infrared light wavelength.

For example, the lighting unit (not shown) may be attached to the front surface of the wearable device 200 or the vicinity thereof. For example, the lighting unit (not shown) may be used in a dark environment or when it is not easy to detect a subject to be captured due to reflected light and combining of various light sources.

In an embodiment, the lighting unit (not shown) may be removed. The lighting unit (not shown) may be replaced with infrared pixels included in the display 221. In an embodiment, the lighting unit (not shown) may be included in the wearable device 200 to assist the infrared pixels included in the display 221.

In an embodiment, the plurality of microphones (not shown) may process an external sound signal to electrical voice data. The electrical audio data may be variously utilized according to a function (or an application being executed) being performed by the wearable device 200.

In an embodiment, the plurality of speakers (not shown) may output audio data received from a communication circuit (e.g., the communication module 190 of FIG. 1) or stored in a memory (e.g., the memory 130 of FIG. 1).

In an embodiment, one or more batteries (not shown) may be included in the wearable device 200. The battery (not shown) may supply power to components of the wearable device 200. In an embodiment, the battery (not shown) may be connected to the connector 250 to receive power from the outside or the counterpart connector 260 through the connector 250.

In an embodiment, the PCB (not shown) may transmit an electrical signal to each module (e.g., a camera, a display, audio, or a sensor) and other PCBs through a flexible PCB (FPCB). In an embodiment, the PCB (not shown) may be connected to the connector 250 to transmit and receive a signal to and from the outside or the counterpart connector 260 through the connector 250.

In an embodiment, a control circuit (not shown) configured to control components of the wearable device 200 except for the display 221 may be disposed on the PCB (not shown). The control circuit (not shown) may control components other than the display 221 and may perform an operation.

In an embodiment, the control circuit (not shown) may include a communication circuit (e.g., the communication module 190 of FIG. 1) or a memory (e.g., the memory 130 of FIG. 1). Without being limited thereto, the control circuit (not shown) in an embodiment may control the display 221 and/or other components. The control circuit (not shown) may be connected to the connector 250 to transmit and receive a signal to and from the outside or the counterpart connector 260 through the connector 250.

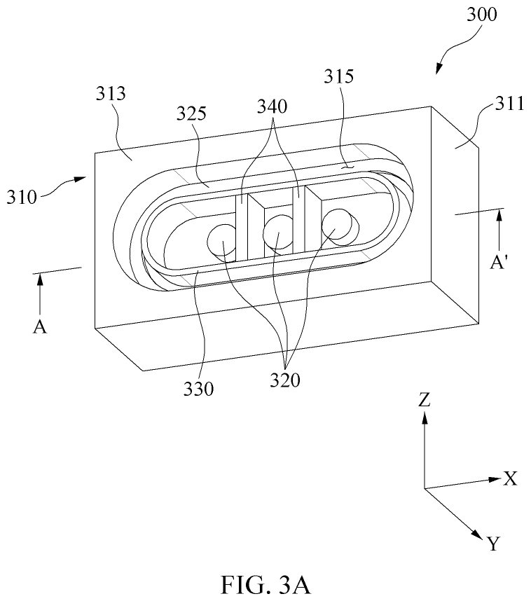

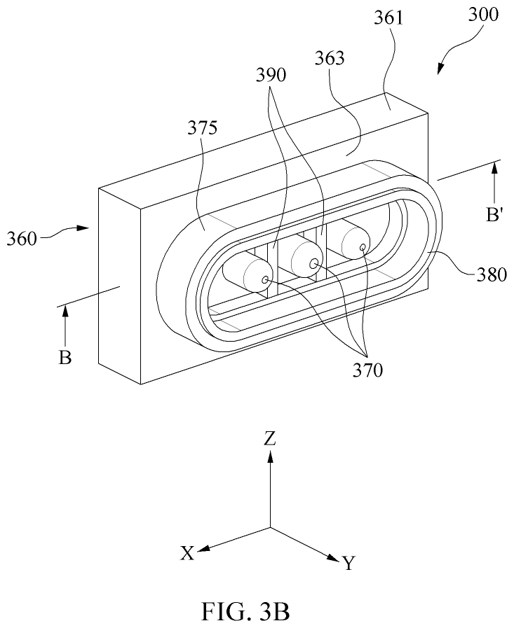

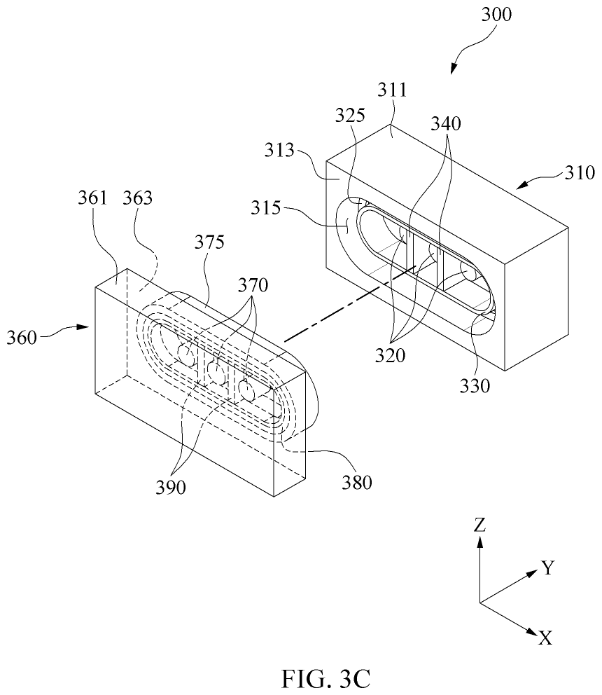

FIG. 3A is a perspective view of a first connector 310 of an electronic device 300 according to an embodiment, FIG. 3B is a perspective view of a second connector 360 of the electronic device 300 according to an embodiment, and FIG. 3C is a perspective view of a combination relationship of the first connector 310 and the second connector 360 of the electronic device 300 according to an embodiment.

For example, the first connector 310 may be a plug and the second connector 360 may be a receptacle that is connectable to the first connector 310. Alternatively, the first connector 310 may be a receptacle and the second connector 360 may be a plug that is connectable to the first connector 310.

Hereinafter, the description provided above is not repeated and it is obvious that a partial component or structure of the first connector 310, the second connector 360, and the electronic device 300 including a portion thereof may be replaced, added, or omitted within an understandable scope by one of ordinary skill in the art with reference to the following drawings and descriptions. In addition, unless it is obviously technically impossible, at least one component or feature of the embodiments described above may be coupled to the first connector 310, the second connector 360, and the electronic device 300 including a portion thereof.

Referring to FIGS. 3A, 3B, and 3C, the electronic device 300 according to an embodiment may include at least one of the first connector 310 and the second connector 360.

In an embodiment, the electronic device 300 (e.g., the electronic device 101 of FIG. 1 or the wearable device 200 of FIGS. 2A and 2B) may include the first connector 310 and the second connector 360 that are interconnectable. Without being limited thereto, the electronic device 300 in an embodiment may include one of the first connector 310 and the second connector 360 and the other may be a counterpart connector of an external electronic device (e.g., the electronic device 102 of FIG. 1) connected to the electronic device 300.

For example, the electronic device 300 may include the first connector 310 and the second connector 360 may be an external counterpart connector of the electronic device 300. The first connector 310 may be an example of the connecting terminal 178 of FIG. 1 or the connector 250 of FIGS. 2A and 2B and the second connector 360 may be an example of the electronic device 102 of FIG. 1 or the counterpart connector 260 of FIGS. 2A and 2B.

Alternatively, for example, the electronic device 300 may include the second connector 360 and the first connector 310 may be an external counterpart connector of the electronic device 300. The second connector 360 may be an example of the connecting terminal 178 of FIG. 1 or the connector 250 of FIG. 2B and the first connector 310 may be an example of the electronic device 102 of FIG. 1 or the counterpart connector 260 of FIG. 2B.

In an embodiment, the first connector 310 may include at least a portion of a first housing 311, a plurality of first terminals 320, and a first magnetic body 325.

In an embodiment, the first housing 311 may support or accommodate other components. For the first housing 311 shown in the drawings, only a partial area in the first housing 311 adjacent to the magnetic body 325 is illustrated for ease of description, and in the actual implementation, the first housing 311 is not limited to the shape and size shown in the drawings. For example, the first housing 311 may be a housing of the wearable device 200 of FIGS. 2A and 2B or the housing of the counterpart connector 260.

In an embodiment, the first housing 311 may include a first surface 313. The first surface 313 may be one surface of the first housing 311 and may be disposed to allow the plurality of first terminals 320 to contact the outside. The first surface 313 may be a surface oriented outward (e.g., the −Y direction) to face the second connector 360 in the first housing 311. Alternatively, the first surface 313 may be one of outer side surfaces exposed to the outside of the electronic device 300 or may be a surface disposed inside the electronic device 300.

In an embodiment, a fastening groove 315 may be formed on the first surface 313. The fastening groove 315 may be an inwardly (e.g., the +Y direction) grooved area from the first surface 313 of the first housing 311. A component (e.g., a plurality of second terminals 370, a second magnetic body 375, and a second barrier 380) of the second connector 360 may be inserted into the fastening groove 315.

In an embodiment, at least some of the plurality of first terminals 320, the first magnetic body 325, a first barrier 330, and a third barrier 340 may be disposed inside the fastening groove 315. The fastening groove 315 may protect the plurality of first terminals 320 by disposing the plurality of first terminals 320 inside the first housing 311.

For example, when the plurality of first terminals 320 is disposed to protrude toward the outside of the first housing 311, the plurality of first terminals 320 may collide with an external object, water or a foreign substance may enter the plurality of first terminals 320 from the outside, or a short circuit or an electrical short may be caused as the plurality of first terminals 320 contacts a conductive (or metallic) material. The fastening groove 315 may prevent or reduce contact between the outside and the plurality of first terminal 320 and may protect the plurality of first terminals 320 by disposing the plurality of first terminals 320 inside the first housing 311.

In an embodiment, the plurality of first terminals 320 may be provided on the first surface 313. The plurality of first terminals 320 may be arranged in a line on the first surface 313. An end of one side (e.g., the −Y direction) of the plurality of first terminals 320 may be exposed to the outside and an end of the other side (e.g., the +Y direction) may be disposed inside the first housing 311.

In an embodiment, the plurality of first terminals 320 may include three terminals as shown in the drawings, or may include two or four or more terminals.

In an embodiment, the plurality of first terminals 320 may be electrically connected to an internal component (e.g., the battery 189 of FIG. 1 or the processor 120 of FIG. 1) of the electronic device 300, an external power supply device (not shown), or an external electronic device (e.g., the electronic device 102 of FIG. 1).

For example, one of the plurality of first terminals 320 may be a cathode power terminal and the other one may be an anode power terminal. Alternatively, one of the plurality of first terminals 320 may be a signal terminal.

In an embodiment, the second connector 360 may include at least a portion of a second housing 361, a plurality of second terminals 370, and a second magnetic body 375.

In an embodiment, the second housing 361 may support or accommodate other components. For the second housing 361 shown in the drawings, only a partial area in the second housing 361 adjacent to the magnetic body 375 is illustrated for ease of description, and in the actual implementation, the second housing 361 is not limited to the shape and size shown in the drawings. For example, the second housing 361 may be a housing of the wearable device 200 of FIGS. 2A and 2B or the housing of the counterpart connector 260.

In an embodiment, the second housing 361 may include a second surface 363. The second surface 363 may be a surface oriented outward (e.g., the +Y direction) to face the first connector 310 in the second housing 361. Alternatively, the second surface 363 may be one of outer side surfaces exposed to the outside of the electronic device 300 or may be a surface disposed inside the electronic device 300.

In an embodiment, the plurality of second terminals 370 may be provided on the second surface 363. The plurality of second terminals 370 may be arranged in a line on the second surface 363. An end of one side (e.g., the +Y direction) of the plurality of second terminals 370 may be exposed to the outside and an end of the other side (e.g., the −Y direction) may be disposed inside the second housing 361.

In an embodiment, the plurality of second terminals 370 may include three terminals as shown in the drawings, or may include two or four or more terminals.

In an embodiment, the plurality of second terminals 370 may be electrically connected to an internal component (e.g., the battery 189 of FIG. 1 or the processor 120 of FIG. 1) of the electronic device 300, an external power supply device (not shown), or an external electronic device (e.g., the electronic device 102 of FIG. 1).

For example, one of the plurality of second terminals 370 may be a cathode power terminal and the other one may be an anode power terminal. Alternatively, one of the plurality of second terminals 370 may be a signal terminal.

In an embodiment, the first magnetic body 325 may be disposed inside the fastening groove 315 on the first surface 313. The first magnetic body 325 may be configured to enclose the plurality of first terminals 320. Based on a cross-section in a direction (e.g., an X-Z direction) substantially parallel with the first surface 313, the first magnetic body 325 may have an elliptical, circular, or polygonal cross-section of which the inside is open.

In an embodiment, the second magnetic body 375 may be disposed on the second surface 363. The second magnetic body 375 may be configured to enclose the plurality of second terminals 370. The first magnetic body 325 and the second magnetic body 375 may be mutually attachable to one another and may be mutually detachable from one another. In an embodiment, at least one of the first magnetic body 325 and the second magnetic body 375 may be replaced with a metallic material or an electromagnetic induction unit.

In an embodiment, the second magnetic body 375 may have a shape corresponding to the first magnetic body 325. For example, while the first connector 310 is coupled to the second connector 360, to closely contact the plurality of first terminals 320 with the plurality of second terminals 370, the first magnetic body 325 and the second magnetic body 375 may have shapes corresponding to each other. Without being limited thereto, the first magnetic body 325 and the second magnetic body 375 may have shapes different from each other or may have shapes corresponding to each other only in at least a partial area.

In an embodiment, the first magnetic body 325 and the second magnetic body 375 may guide the connection between the first connector 310 and the second connector 360. The first magnetic body 325 and the second magnetic body 375 may attract each other by exerting an attractive force by a magnetic force.

In an embodiment, the user may easily connect the first connector 310 to the second connector 360 through the first magnetic body 325 and the second magnetic body 375. A coupling position to which the strongest attractive force is applied may exist between the first magnetic body 325 and the second magnetic body 375 depending on magnetic characteristics. The first magnetic body 325 and the second magnetic body 375 may guide a connecting position between the plurality of first terminals 320 and the plurality of second terminals 370 by connecting the first connector 310 to the second connector 360 at the coupling position within a predetermined range.

In an embodiment, the first magnetic body 325 and the second magnetic body 375 may provide connection stability and convenience of the first connector 310 and the second connector 360. By a magnetic force between the first magnetic body 325 and the second magnetic body 375, an external force greater than or equal to a predetermined range in a coupling direction may be required to separate the first connector 310 from the second connector 360.

In an embodiment, when the first housing 311 moves or travels while the first connector 310 is connected to the second connector 360, the connection between the first connector 310 and the second connector 360 may be maintained by the magnetic force between the first magnetic body 325 and the second magnetic body 375.

For example, when the first housing 311 is a wearable device (e.g., the wearable device 200 of FIGS. 2A and 2B) or a portable electronic device (e.g., the electronic device 300), the first housing 311 may need to be moved to use while the first connector 310 is connected to the second connector 360. By the first magnetic body 325 and the second magnetic body 375, the user may use the wearable device 200 or the portable electronic device 300 while freely moving the first housing 311 while the first connector 310 is connected to the second connector 360.

In an embodiment, the electronic device 300 may include at least a portion of a plurality of barriers 330, 340, 380, and 390. The plurality of barriers 330, 340, 380, and 390 may prevent a foreign substance from entering or attaching to the plurality of first terminals 320 and/or the plurality of second terminals 370. In addition, the plurality of barriers 330, 340, 380, and 390 may protect the plurality of first terminals 320 and/or the plurality of second terminals 370 from external impact.

In an embodiment, at least a portion of the plurality of barriers 330, 340, 380, and 390 may include plastic-type resin, such as PP, ABS, PA, PET, PC, PE, PMMA, or PVC, or synthetic resin including at least a portion thereof. The materials of the plurality of barriers 330, 340, 380, and 390 may be the same or similar, or, without being limited thereto, the plurality of barriers 330, 340, 380, and 390 may include different materials from each other.

Hereinafter, the first connector 310 and the second connector 360 including the plurality of barriers 330, 340, 380, and 390 according to various embodiments of the present disclosure are described. The drawings and descriptions below are examples of various embodiments. In the actual implementation, the examples are not limited thereto and may be modified with various shapes, sizes, structures, and/or arrangements.

Hereinafter, the term “inside” or “inner” may refer to a direction facing the center of the first surface 313 in the first housing 311 from the outside or a direction facing the center of the second surface 363 in the second housing 361 from the outside. Further, the term “outside” or “outer” may refer to a direction facing the outside from the center of the first surface 313 in the first housing 311 or a direction facing the outside from the center of the second surface 363 in the second housing 361.

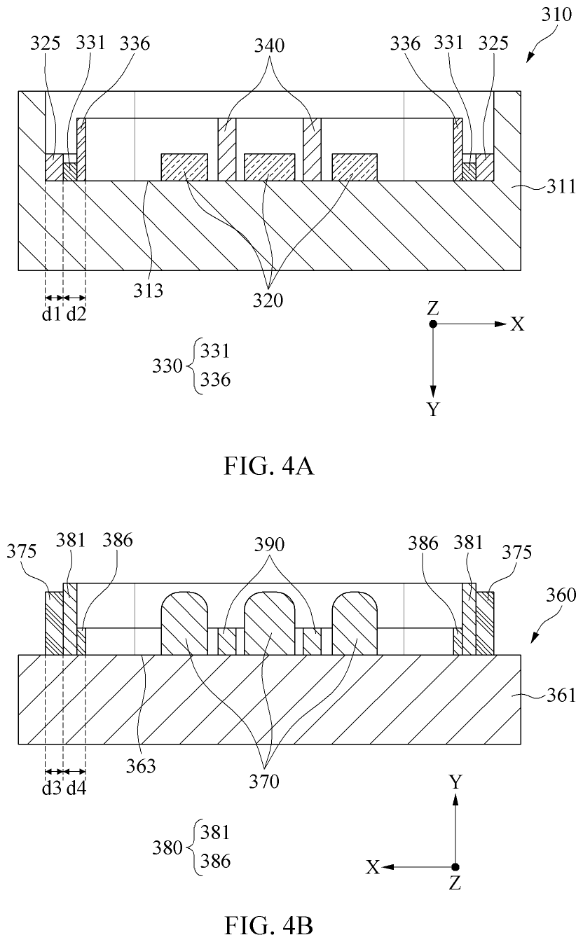

FIG. 4A is a cross-sectional view of the first connector 310 according to an embodiment and FIG. 4B is a cross-sectional view of the second connector 360 according to an embodiment.

For example, FIG. 4A is a cross-sectional view of the first connector 310 taken along a line A-A′ of FIG. 3A and FIG. 4B is a cross-sectional view of the second connector 360 taken along a line B-B′ of FIG. 3B.

Referring to FIGS. 4A and 4B, the first connector 310 according to an embodiment may further include at least one of the first barrier 330 and the second barrier 340 and the second connector 360 may further include at least one of the second barrier 380 and the fourth barrier 390.

Hereinafter, the description provided above is not repeated and it is obvious that a partial component or structure of the first connector 310, the second connector 360, and the electronic device 300 including a portion thereof may be replaced, added, or omitted within an understandable scope by one of ordinary skill in the art with reference to the following drawings and descriptions. In addition, unless it is obviously technically impossible, at least one component or feature of the embodiments described above may be coupled to the first connector 310, the second connector 360, and the electronic device 300 including a portion thereof.

In an embodiment, the first barrier 330 may be disposed to enclose an inner side surface of the first magnetic body 325. For example, the first barrier 330 may extend while enclosing the inner side surface of the first magnetic body 325 in a direction in which the first magnetic body 325 extends in a horizontal direction (e.g., the X-Z plane direction).

In an embodiment, the first barrier 330 may be formed as one body with the first housing 311. The first barrier 330 may be formed by injection molding as one continuous body with the first housing 311 or may be formed by double-shot injection with the first housing 311. Alternatively, the first barrier 330 may be molded separately from the first housing 311 and may be coupled to the first housing 311.

In an embodiment, at least in a partial area, the first barrier 330 may extend higher than the first magnetic body 325 from the first surface 313. For example, as shown in FIG. 4A, the first barrier 330 may include a partial area (e.g., a first inner barrier 336) extending higher than the first magnetic body 325 upwardly (e.g., the −Y direction). Alternatively, although not shown in the drawings, the first barrier 330 may extend, from the first surface 313, higher than the first magnetic body 325 in all areas. Alternatively, at least in a partial area, the first barrier 330 may extend at the same height as the first magnetic body 325 from the first surface 313.

In an embodiment, the first barrier 330 may prevent a foreign substance from attaching to the first magnetic body 325. When the magnetic force of the first magnetic body 325 decreases, the coupling of the first connector 310 to the second connector 360 may not be guided or the first connector 310 may be relatively easily removed from the second connector 360. In addition, when the magnetic force of the first magnetic body 325 increases, a metallic foreign substance may enter from the outside and may be attached to the first magnetic body 325 or may affect the plurality of first terminals 320.

The first barrier 330 according to an embodiment of the present disclosure may restrict the magnetic force applied in an inner direction (e.g., a central direction of the first housing 311) of the first magnetic body 325 and may prevent or reduce a problem of an inflow of foreign substances from the outside of the electronic device 300 due to the magnetic force of the first magnetic body 325 while maintaining the magnetic force for coupling the first magnetic body 325 to the second magnetic body 375.

In an embodiment, the first barrier 330 may guide to restrict movement of a foreign substance entering the first connector 310 toward the plurality of first terminals 320. The plurality of first terminals 320 may be disposed in the first magnetic body 325 and when a foreign substance enters toward the plurality of first terminals 320, the plurality of first terminals 320 may collide with an external object, the foreign substance may be attached to the plurality of first terminals 320, or the plurality of first terminals 320 may be short-circuited or disconnected. The first barrier 330 may reduce or prevent an inflow of a foreign substance in the direction of the plurality of first terminals 320 and may protect the plurality of first terminals 320.

In an embodiment, the first barrier 330 may be substantially in close contact with the inner side surface of the first magnetic body 325. The first barrier 330 may restrict a magnetic force applied in an inner direction (e.g., the central direction of the first housing 311) of the first magnetic body 325 and may physically protect the first magnetic body 325. The first barrier 330 may prevent a metallic foreign substance from attaching to the inside of the first magnetic body 325 or may assist in easily removing an attached foreign substance.

In an embodiment, the first magnetic body 325 may be substantially in close contact with the inner side surface of the fastening groove 315 of the first housing 311. The first housing 311 may restrict a magnetic force applied in an outer direction (e.g., the opposite direction to the center of the first housing 311) of the first magnetic body 325 and may physically protect the first magnetic body 325. The first housing 311 may prevent a metallic foreign substance from attaching to the outside of the first magnetic body 325.

In an embodiment, the second barrier 380 may be disposed to enclose an inner side surface of the second magnetic body 375. For example, the second barrier 380 may extend while enclosing the inner side surface of the second magnetic body 375 in a direction in which the second magnetic body 375 extends in a horizontal direction (e.g., the X-Z plane direction).

In an embodiment, the second barrier 380 may be formed as one body with the second housing 361. The second barrier 380 may be formed by injection molding as one continuous body with the second housing 361 or may be formed by double-shot injection with the second housing 361. Alternatively, the second barrier 380 may be molded separately from the second housing 361 and may be coupled to the second housing 361.

In an embodiment, at least in a partial area, the second barrier 380 may extend higher than the second magnetic body 375 from the second surface 363. For example, as shown in FIG. 4B, the second barrier 380 may include a partial area (e.g., a second outer barrier 381) extending higher than the second magnetic body 375 upwardly (e.g., the +Y direction). Alternatively, although not shown in the drawings, the second barrier 380 may extend, from the second surface 363, higher than the second magnetic body 375 in all areas. Alternatively, at least in a partial area, the second barrier 380 may extend at the same height as the second magnetic body 375 from the second surface 363.

In an embodiment, the second barrier 380 may prevent a foreign substance from attaching to the second magnetic body 375. When the magnetic force of the second magnetic body 375 decreases, the coupling of the first connector 310 to the second connector 360 may not be guided or the first connector 310 may be relatively easily removed from the second connector 360. When the magnetic force of the second magnetic body 375 increases, a metallic foreign substance may enter from the outside and may be attached to the second magnetic body 375.

In an embodiment, the second barrier 380 may guide a foreign substance entering the second connector 360 to be attached to the outer side of the second magnetic body 375. The plurality of second terminals 370 may be provided in the second magnetic body 375 and when a foreign substance enters toward the plurality of second terminals 370, the plurality of second terminals 370 may collide with an external object, the foreign substance may be attached to the plurality of second terminals 370, or the plurality of second terminals 370 may be short-circuited or disconnected. The second barrier 380 may protect the plurality of second terminals 370 by preventing an inflow of a foreign substance or guiding a foreign substance to the outer side of the second magnetic body 375.

The second barrier 380 according to an embodiment of the present disclosure may restrict the magnetic force applied in an inner direction (e.g., a central direction of the second housing 361) of the second magnetic body 375 and may prevent or reduce a problem of the inflow of foreign substances from the outside due to the magnetic force of the second magnetic body 375 while maintaining the magnetic force for coupling the second magnetic body 375 to the first magnetic body 325.

In an embodiment, the second barrier 380 may be substantially in close contact with the inner side surface of the second magnetic body 375. The second barrier 380 may restrict a magnetic force applied in an inner direction (e.g., the central direction of the second housing 361) of the second magnetic body 375 and may physically protect the second magnetic body 375. The second barrier 380 may prevent a metallic foreign substance from attaching to the inside of the second magnetic body 375 or may assist in easily removing an attached foreign substance.

In an embodiment, the first barrier 330 may include a first outer barrier 331 and a first inner barrier 336. The first outer barrier 331 and the first inner barrier 336 may be formed as one body or may be formed separately and then coupled.

In an embodiment, the first outer barrier 331 may be in contact with the inner side surface of the first magnetic body 325 and may extend lower than the first magnetic body 325 from the first surface 313. The first inner barrier 336 may be in contact with the inner side surface of the first outer barrier 331 and may extend higher than the first magnetic body 325 from the first surface 313.

In an embodiment, the second barrier 380 may include a second outer barrier 381 and the second inner barrier 386. The second outer barrier 381 and the second inner barrier 386 may be formed as one body or may be formed separately and then coupled.

In an embodiment, the second outer barrier 381 may be in contact with the inner side surface of the second magnetic body 375 and may extend lower than the second magnetic body 375 from the second surface 363. The second inner barrier 386 may be in contact with the inner side surface of the second outer barrier 381 and may extend higher than the second magnetic body 375 from the second surface 363.

In an embodiment, when the first connector 310 and the second connector 360 are coupled to each other, the first outer barrier 331 may face the second outer barrier 381 and the first inner barrier 336 may face the second inner barrier 386. As the first outer barrier 331 extends relatively lower than the first inner barrier 336 and the second inner barrier 386 extends relatively lower than the second outer barrier 381, partial areas of the first barrier 330 and the second barrier 380 may be formed higher than the first magnetic body 325 and the second magnetic body 375, respectively, and the first barrier 330 and the second barrier 380 may be coupled to face each other.

In an embodiment, the first magnetic body 325 may have a first width d1 based on a cross-section perpendicular to the first surface 313. The first barrier 330 may have a second width d2 that is greater than the first width d1 based on the cross-section perpendicular to the first surface 313. By forming the second width d2 greater than the first width d1, the first barrier 330 may effectively prevent a foreign substance from attaching in the inner direction of the first magnetic body 325.

In an embodiment, the second magnetic body 375 may have a third width d3 based on a cross-section perpendicular to the second surface 363. The second barrier 380 may have a fourth width d4 that is greater than the third width d3 based on the cross-section perpendicular to the second surface 363. By forming the fourth width d4 greater than the third width d3, the second barrier 380 may effectively prevent a foreign substance from attaching in the inner direction of the second magnetic body 375.

In an embodiment, the third barrier 340 may be disposed between two of the plurality of first terminals 320. For example, when the first terminals 320 are arranged in a line, the third barrier 340 may be iteratively disposed between two adjacent first terminals 320.

The third barrier 340 according to an embodiment of the present disclosure may prevent a foreign substance from entering between the plurality of first terminals 320. For example, when a foreign substance enters between the plurality of first terminals 320, the plurality of first terminals 320 may collide with an external object, the foreign substance may be attached to the plurality of first terminals 320, or the plurality of first terminals 320 may be short-circuited or disconnected. The third barrier 340 may reduce or prevent an inflow of a foreign substance between the plurality of first terminals 320 and may protect the plurality of first terminals 320.

In an embodiment, the fourth barrier 390 may be disposed between two of the plurality of second terminals 370. For example, when the second terminals are 370 arranged in a line, the fourth barrier 390 may be iteratively disposed between two adjacent second terminals 370.

The fourth barrier 390 according to an embodiment of the present disclosure may prevent a foreign substance from entering between the plurality of second terminals 370. For example, when a foreign substance enters between the plurality of second terminals 370, the plurality of second terminals 370 may collide with an external object, the foreign substance may be attached to the plurality of second terminals 370, or the plurality of second terminals 370 may be short-circuited or disconnected. The fourth barrier 390 may reduce or prevent an inflow of a foreign substance between the plurality of second terminals 370 and may protect the plurality of second terminals 370.

In an embodiment, at least in a partial area, the third barrier 340 may extend higher than the plurality of first terminals 320 from the first surface 313. In at least a partial area, the fourth barrier 390 may extend lower than the plurality of second terminals 370 from the second surface 363.

In an embodiment, when the first connector 310 and the second connector 360 are coupled to each other, the third barrier 340 and the fourth barrier 390 may face each other. As the fourth barrier 390 extends lower than the plurality of second terminals 370, the third barrier 340 may be formed higher than the plurality of first terminals 320, the first barrier 330 and the second barrier 380 may be coupled to face each other, and coupling stability between the first connector 310 and the second connector 360 may be improved.

In an embodiment, when the first barrier 330 and the second barrier 380 are coupled to face each other while the first connector 310 and the second connector 360 are coupled to each other, the third barrier 340 and the fourth barrier 390 may be coupled to face each other and the coupling stability between the first connector 310 and the second connector 360 may be improved.

In an embodiment, even when the first barrier 330 and the second barrier 380 are not coupled to face each other while the first connector 310 and the second connector 360 are coupled to each other, the third barrier 340 and the fourth barrier 390 may be coupled to face each other and the coupling stability between the first connector 310 and the second connector 360 may be provided.

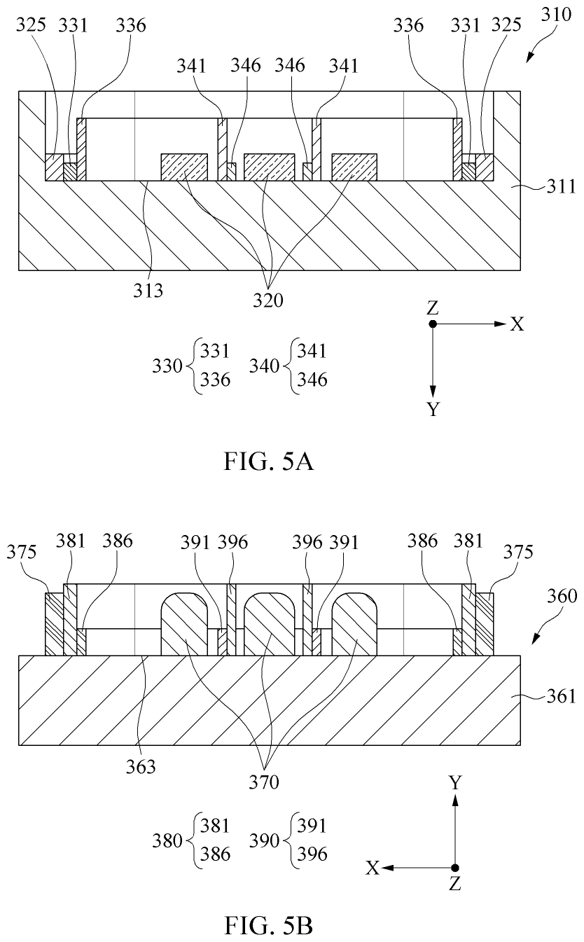

FIG. 5A is a cross-sectional view of the first connector 310 according to an embodiment and FIG. 5B is a cross-sectional view of the second connector 360 according to an embodiment.

Referring to FIGS. 5A and 5B, the third barrier 340 according to an embodiment may include a third outer barrier 341 and a third inner barrier 346 and the fourth barrier 390 may include a fourth outer barrier 391 and a fourth inner barrier 396.

Hereinafter, the description provided above is not repeated and it is obvious that a partial component or structure of the first connector 310, the second connector 360, and the electronic device 300 including a portion thereof may be replaced, added, or omitted within an understandable scope by one of ordinary skill in the art with reference to the following drawings and descriptions. In addition, unless it is obviously technically impossible, at least one component or feature of the embodiments described above may be coupled to the first connector 310, the second connector 360, and the electronic device 300 including a portion thereof.

In an embodiment, the third barrier 340 may include the third outer barrier 341 and the third inner barrier 346. The third outer barrier 341 and the third inner barrier 346 may be formed as one body or may be formed separately and then coupled.

In an embodiment, the third outer barrier 341 may extend higher than the plurality of first terminals 320 from the first surface 313. The third inner barrier 346 may be in contact with the inner side surface of the third outer barrier 341 and may extend lower than the plurality of first terminals 320 from the first surface 313.

In an embodiment, by including the third outer barrier 341, a partial area of the third barrier 340 may be formed higher than the plurality of first terminals 320, may efficiently reduce or prevent an inflow of a foreign substance between the plurality of first terminals 320, and may protect the plurality of first terminals 320.

In an embodiment, the fourth barrier 390 may include the fourth outer barrier 391 and the fourth inner barrier 396. The fourth outer barrier 391 and the fourth inner barrier 396 may be formed as one body or may be formed separately and then coupled.

In an embodiment, the fourth outer barrier 391 may extend lower than the plurality of second terminals 370 from the second surface 363. The fourth inner barrier 396 may be in contact with the inner side surface of the fourth outer barrier 391 and may extend higher than the plurality of second terminals 370 from the second surface 363.

In an embodiment, by including the fourth inner barrier 396, a partial area of the fourth barrier 390 may be formed higher than the plurality of second terminals 370, may efficiently reduce or prevent an inflow of a foreign substance between the plurality of first terminals 320, and may protect the plurality of second terminals 370.

In an embodiment, when the first connector 310 and the second connector 360 are coupled to each other, the third outer barrier 341 may face the fourth outer barrier 391 and the third inner barrier 346 may face the fourth inner barrier 396.

In an embodiment, as the third inner barrier 346 extends relatively lower than the third outer barrier 341 and the fourth outer barrier 391 extends relatively lower than the fourth inner barrier 396, partial areas of the third barrier 340 and the fourth barrier 390 may be formed higher than the plurality of first terminals 320 and the plurality of second terminals 370, respectively, and the third barrier 340 and the fourth barrier 390 may be coupled to face each other.

In further embodiments, numbers of one or more of the third outer barrier 341, the third inner barrier 346, the fourth outer barrier 391 and the fourth inner barrier 396 can be increased. As an example, each third outer barrier 341 can be sandwiched between a corresponding pair of third inner barriers 346 and each fourth outer barrier 391 can be sandwiched between a corresponding pair of further inner barriers 396. In these or other cases, the resulting structure may substantially reduce or prevent inflows of foreign substances between the plurality of first terminals 320 and may protect the plurality of second terminals 370.

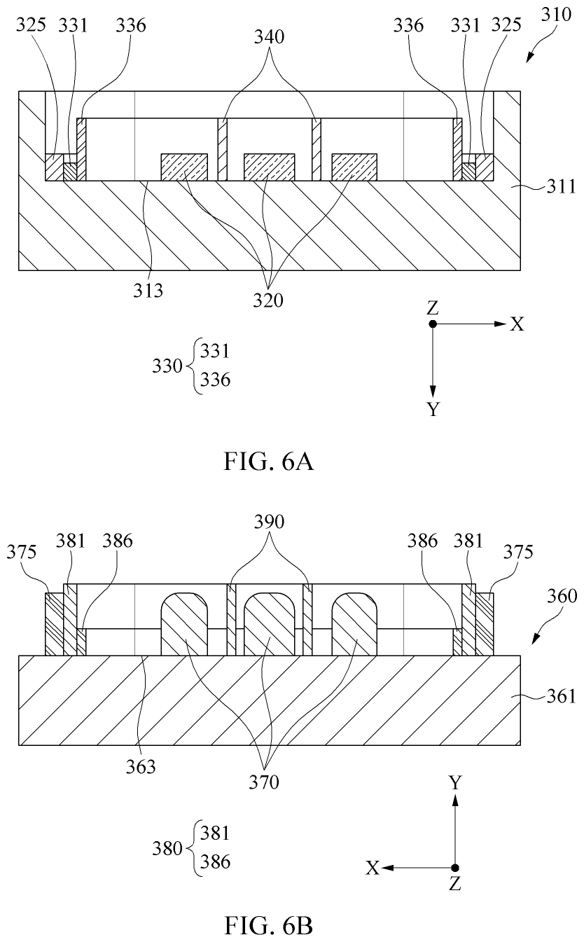

FIG. 6A is a cross-sectional view of the first connector 310 according to an embodiment and FIG. 6B is a cross-sectional view of the second connector 360 according to an embodiment.

Referring to FIGS. 6A and 6B, the third barrier 340 and the fourth barrier 390 according to an embodiment may be disposed not to face each other.

Hereinafter, the description provided above is not repeated and it is obvious that a partial component or structure of the first connector 310, the second connector 360, and the electronic device 300 including a portion thereof may be replaced, added, or omitted within an understandable scope by one of ordinary skill in the art with reference to the following drawings and descriptions. In addition, unless it is obviously technically impossible, at least one component or feature of the embodiments described above may be coupled to the first connector 310, the second connector 360, and the electronic device 300 including a portion thereof.

In an embodiment, the third barrier 340 may extend higher than the plurality of first terminals 320 from the first surface 313. The fourth barrier 390 may extend higher than the plurality of second terminals 370 from the second surface 363.

In an embodiment, when the third barrier 340 and the fourth barrier 390 extend higher than the plurality of first terminals 320 and the plurality of second terminals 370, respectively, the third barrier 340 may collide with the fourth barrier 390 while coupling the first connector 310 to the second connector 360. To prevent the collision, the third barrier 340 and the fourth barrier 390 may be disposed not to face each other.

In an embodiment, the third barrier 340 and the fourth barrier 390 may be disposed adjacent to each other in a mutual side direction (e.g., the X-axis direction) based on a state in which the first connector 310 is connected to the second connector 360.

For example, the third barrier 340 may be disposed relatively closer to the outer first terminal 320 of two of the plurality of first terminals 320. The fourth barrier 390 may be disposed relatively closer to the inner second terminal 370 of two of the plurality of second terminals 370.

Alternatively, for example, the third barrier 340 may be disposed relatively closer to the inner first terminal 320 of two of the plurality of first terminals 320. The fourth barrier 390 may be disposed relatively closer to the outer second terminal 370 of two of the plurality of second terminals 370.

In an embodiment, as the third barrier 340 and the fourth barrier 390 are disposed not to face each other in a mutual coupling direction (e.g., the Y-axis direction), while the first connector 310 and the second connector 360 are coupled to each other, the third barrier 340 and the fourth barrier 390 may be formed higher than the plurality of first terminals 320 and the plurality of second terminals 370, respectively, the third barrier 340 and the fourth barrier 390 may not collide with each other and may be disposed adjacent to each other in the side direction (e.g., the X-Z plane direction), and the first barrier 330 and the second barrier 380 may be coupled to face each other.

In further embodiments, numbers of one or more of the third barrier 340 and the fourth barrier 390 can be increased. For example, each third barrier 340 can be provided as a pair of third barriers 340 whereby when connection is made, the pairs of the third barriers 340 sandwich the corresponding fourth barriers 390. In these or other cases, the resulting structure may substantially reduce or prevent inflows of foreign substances between the plurality of first terminals 320 and may protect the plurality of second terminals 370.

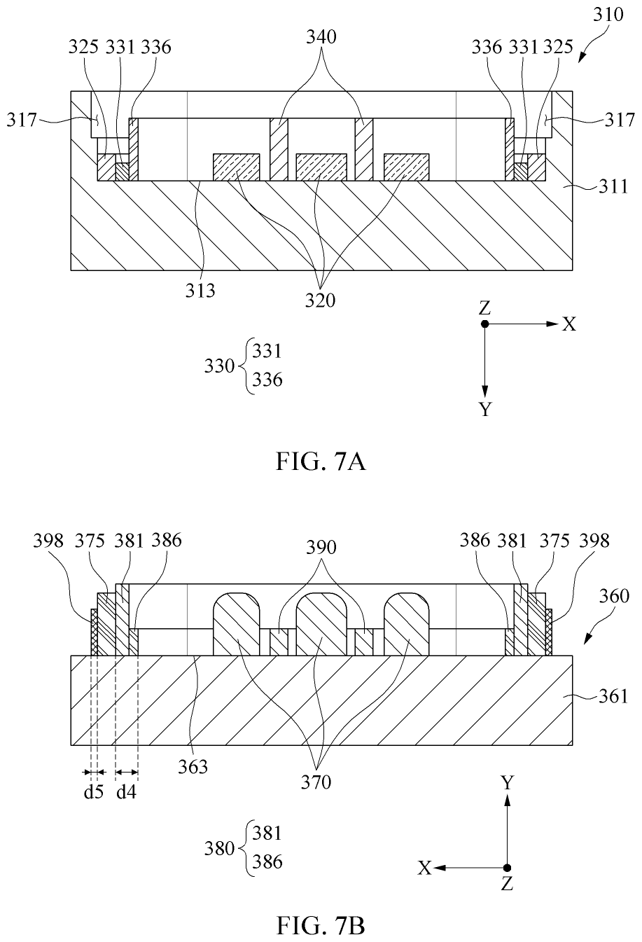

FIG. 7A is a cross-sectional view of the first connector 310 according to an embodiment and FIG. 7B is a cross-sectional view of the second connector 360 according to an embodiment.

Referring to FIGS. 7A and 7B, the second connector 360 according to an embodiment may further include a fifth barrier 398.

Hereinafter, the description provided above is not repeated and it is obvious that a partial component or structure of the first connector 310, the second connector 360, and the electronic device 300 including a portion thereof may be replaced, added, or omitted within an understandable scope by one of ordinary skill in the art with reference to the following drawings and descriptions. In addition, unless it is obviously technically impossible, at least one component or feature of the embodiments described above may be coupled to the first connector 310, the second connector 360, and the electronic device 300 including a portion thereof.

In an embodiment, the fifth barrier 398 may be disposed to enclose an outer side surface of the second magnetic body 375. The first housing 311 may further include a barrier groove 317, which is a partially open space to be coupled to the fifth barrier 398 while facing the fifth barrier 398.

In an embodiment, the fifth barrier 398 may be substantially in close contact with the outer surface of the second magnetic body 375. The fifth barrier 398 may restrict a magnetic force applied in the outer direction of the second magnetic body 375 and may protect the second magnetic body 375. The fifth barrier 398 may prevent a metallic foreign substance from attaching to the outside of the magnetic body 375 or may assist in easily removing an attached foreign substance.

In an embodiment, at least in a partial area, the fifth barrier 398 may extend lower than the second magnetic body 375 from the second surface 363. As the fifth barrier 398 extends lower than the second magnetic body 375, the barrier groove 317 may be disposed upwardly (e.g., the −Y direction) than the outer side surface of the first magnetic body 325 and the outer side surface of the first magnetic body 325 may not be exposed to the outside of the first housing 311 and may be protected.

In an embodiment, the second barrier 380 may have a fourth width d4 based on a cross-section perpendicular to the second surface 363. The fourth barrier 390 may have a fifth width d5 that is less than the fourth width d4 based on a cross-section perpendicular to the second surface 363. As the fifth width d5 is formed smaller than the fourth width d4, the magnetic force of the second magnetic body 375 may be applied relatively greater in the outer direction than in the inner direction. Through this, the fifth barrier 398 may guide a foreign substance in the outer direction of the magnetic body 375 to prevent the foreign substance from attaching in the inner direction of the second magnetic body 375.

In an embodiment, while the first connector 310 and the second connector 360 are coupled to each other, the fifth barrier 398 may be disposed in the barrier groove 317, the first barrier 330 and the second barrier 380 may be coupled to face each other, and coupling stability between the first connector 310 and the second connector 360 may be improved.

In an embodiment, while the first connector 310 and the second connector 360 are coupled to each other, the fifth barrier 398 may be disposed in the barrier groove 317, the third barrier 340 and the fourth barrier 390 may be coupled to face each other, and coupling stability between the first connector 310 and the second connector 360 may be improved.

In an embodiment, even when the first barrier 330 and the second barrier 380 are not coupled to face each other, the third barrier 340 and the fourth barrier 390 may be coupled to face each other and the coupling stability between the first connector 310 and the second connector 360 may be provided.

In further embodiments, the third barrier 340 and the fourth barrier 390 can be provided with a tongue-and-groove structure whereby when connection is made the tongue-and-groove structures fit together tightly. In these or other cases, the resulting structure may substantially reduce or prevent inflows of foreign substances between the plurality of first terminals 320 and may protect the plurality of second terminals 370.

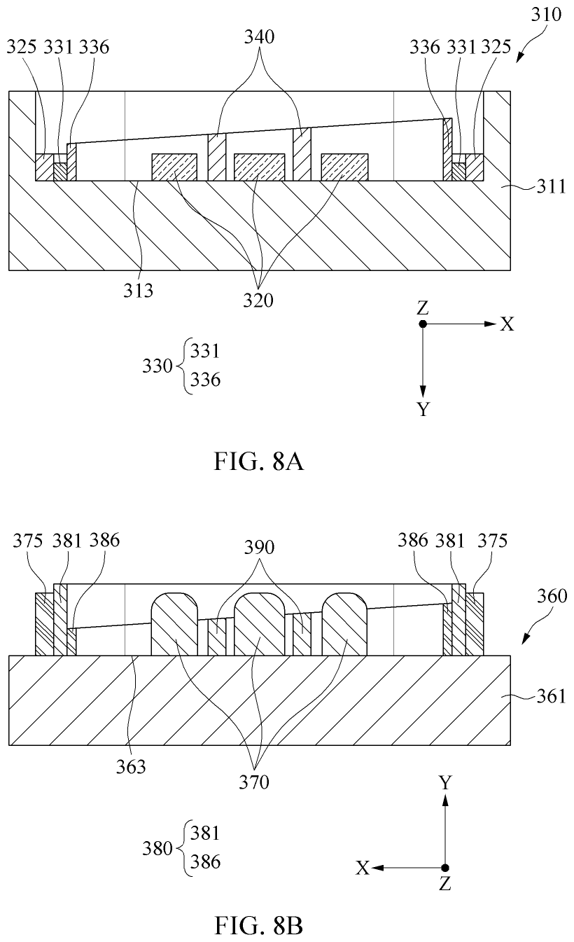

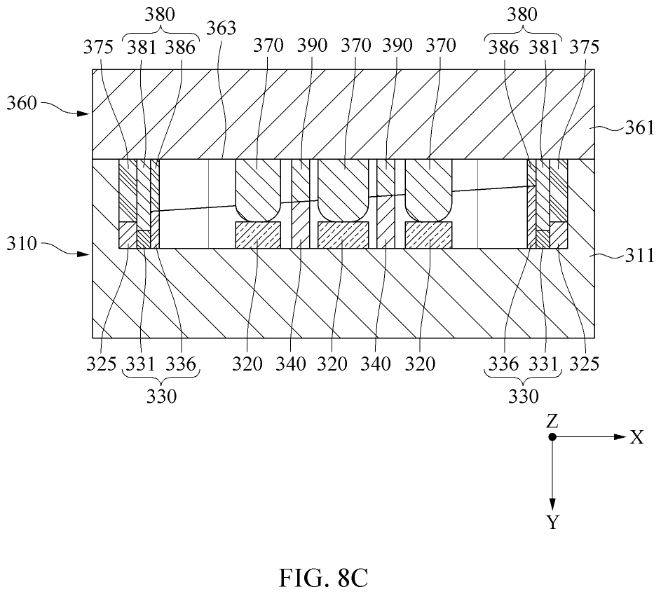

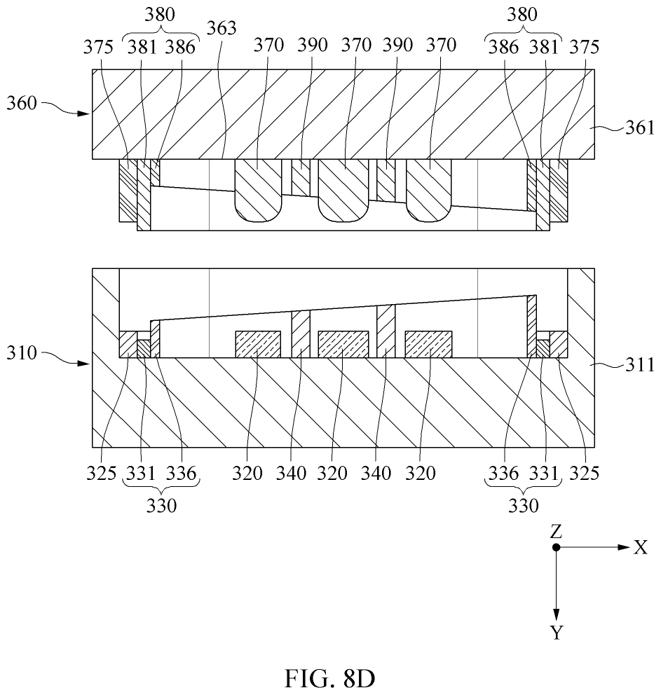

FIG. 8A is a cross-sectional view of the first connector 310 according to an embodiment, FIG. 8B is a cross-sectional view of the second connector 360 according to an embodiment, FIG. 8C is a cross-sectional view of a combination state of the first connector 310 and the second connector 360 according to an embodiment, and FIG. 8D is a cross-sectional view of a state in which the first connector 310 and the second connector 360 face each other according to an embodiment.

Specifically, FIG. 8C is a diagram illustrating a state in which the first connector 310 and the second connector 360 are electrically connected to each other and FIG. 8D is a diagram illustrating a state in which the first connector 310 and the second connector 360 are not allowed to be connected to each other when the second connector 360 is reversely inserted into the first connector 310.

Referring to FIGS. 8A, 8B, 8C, and 8D, the first barrier 330 and the second barrier 380 according to an embodiment may vary their heights depending on positions.

Hereinafter, the description provided above is not repeated and it is obvious that a partial component or structure of the first connector 310, the second connector 360, and the electronic device 300 including a portion thereof may be replaced, added, or omitted within an understandable scope by one of ordinary skill in the art with reference to the following drawings and descriptions. In addition, unless it is obviously technically impossible, at least one component or feature of the embodiments described above may be coupled to the first connector 310, the second connector 360, and the electronic device 300 including a portion thereof.

In an embodiment, the first barrier 330 may be configured to increase or decrease the height in a direction in which the first barrier 330 develops while enclosing the first magnetic body 325. For example, as the first barrier 330 develops in a direction (e.g., the +X direction) parallel with the first surface 313, the first barrier 330 may gradually or within a predetermined area, increase or decrease the height.

In an embodiment, the second barrier 380 may be configured to gradually decrease or increase the height in a direction in which the second barrier 380 extends at a ratio corresponding to the height change of the first barrier 330 while enclosing the second magnetic body 375. For example, as the second barrier 380 develops in a direction (e.g., the −X direction) parallel with the second surface 363, the second barrier 380 may gradually or within a predetermined area, increase or decrease the height.

As shown in FIGS. 8C and 8D, as the first barrier 330 and the second barrier 380 change their heights to correspond to each other, the first barrier 330 and the second barrier 380 may guide an insertion direction of the first connector 310 and the second connector 360 and may prevent a reverse insertion problem of the first connector 310 and the second connector 360.

In an embodiment, when the first connector 310 and the second connector 360 are coupled to each other, the first barrier 330 and the second barrier 380 may face each other. As the first barrier 330 and the second barrier 380 change their heights to correspond to each other, the first connector 310 and the second connector 360 may be guided not to be coupled in a reverse insertion direction. Accordingly, the first barrier 330 and the second barrier 380 may guide the insertion direction of the first connector 310 and the second connector 360 and may improve coupling stability between the first connector 310 and the second connector 360.

In an embodiment, as shown in FIG. 8D, when the second connector 360 is reversely inserted into the first connector 310, the first barrier 330 and the second barrier 380 may prevent the connection between the plurality of first terminals 320 and the plurality of second terminals 370.

In an embodiment, when the first barrier 330 and the second barrier 380 do not face each other, the first connector 310 may be reversely inserted into the second connector 360 and may be incorrectly connected and an improper connection may occur between the plurality of first terminals 320 and the plurality of second terminals 370. For example, the improper connection may occur as an anode power terminal, which is one of the plurality of first terminals 320, is connected to an anode power terminal, which is one of the plurality of second terminals 370.

As shown in FIG. 8D, when the second connector 360 is reversely inserted into the first connector 310, at least some of the plurality of first terminals 320 and the plurality of second terminals 370 may not be in contact with each other due to a height difference between the first connector 310 and the second connector 360. Accordingly, the first connector 310 and the second connector 360 may not be electrically connected to each other and the improper connection between the first connector 310 and the second connector 360 may be prevented.

In an embodiment, when the first barrier 330 and the second barrier 380 are coupled to face each other while the first connector 310 and the second connector 360 are coupled to each other, the third barrier 340 and the fourth barrier 390 may be coupled to face each other and the coupling stability between the first connector 310 and the second connector 360 may be improved.

In an embodiment, even when the first barrier 330 and the second barrier 380 are not coupled to face each other, the third barrier 340 and the fourth barrier 390 may be coupled to face each other and the coupling stability between the first connector 310 and the second connector 360 may be provided.

In the drawings, the first inner barrier 336 of the first barrier 330 and the second inner barrier 386 of the second barrier 380 are developed in a specific direction and their heights gradually change. However, the actual implementation is not limited thereto.

For example, the height of at least one of the first outer barrier 331 and the first inner barrier 336 of the first barrier 330 and the height of at least one of the second outer barrier 381 and the second inner barrier 386 of the second barrier 380 may change.

For example, the third barrier 340 may be configured to increase or decrease the height in a direction (e.g., the Z-axis direction) in which the third barrier 340 develops while partitioning the plurality of first terminals 320 and the fourth barrier 390 may be configured to gradually increase or decrease the height in a direction (e.g., the Z-axis direction) in which the fourth barrier 390 develops while partitioning the plurality of second terminals 370 at a ratio corresponding to the height change of the third barrier 340.

For example, the height changes of the first barrier 330 and the second barrier 380 may be continuous, iterative, or irregular. The structures and shapes of the first barrier 330 and the second barrier 380 may be variously implemented to allow the first connector 310 and the second connector 360 to be coupled to each other while facing each other.

Without being limited thereto, the heights of the third barrier 340 and the fourth barrier 390 according to an embodiment may also change while being developed in a direction.

For example, the height of the third barrier 340 may gradually increase as the third barrier 340 develops in a direction (e.g., the +X direction) on the first surface 313. Alternatively, when a plurality of third barriers 340 is provided, the height of one of the third barriers 340 may be higher than other third barriers 340 at least in a partial area.

For example, the height of the fourth barrier 390 may gradually increase as the fourth barrier 390 develops in a direction (e.g., the −X direction) on the second surface 363. Alternatively, when a plurality of fourth barriers 390 is provided, the height of one of the fourth barriers 390 may be higher than other third barriers 390 at least in a partial area.

In further embodiments, the first barrier 330 and the second barrier 380 may have a complex geometry with corresponding increases and decreases in height. For example, the first barrier 330 may increase in height from each side to have a maximum height between the first terminals 320 and the second barrier 380 may decrease in height from each side to have a minimum height between the second terminals 370. In these or other cases, the resulting structure may substantially reduce or prevent inflows of foreign substances between the plurality of first terminals 320 and may protect the plurality of second terminals 370.

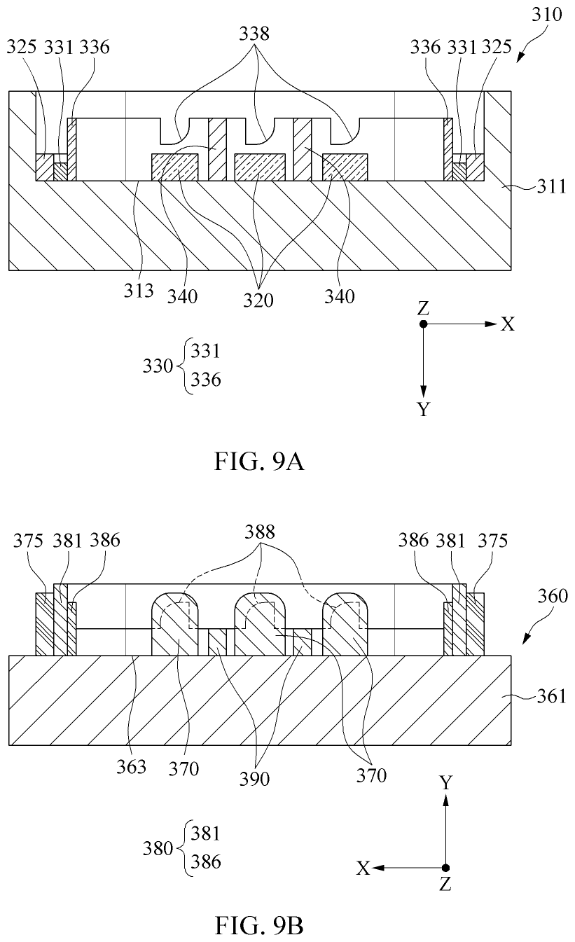

FIG. 9A is a cross-sectional view of the first connector 310 according to an embodiment and FIG. 9B is a cross-sectional view of the second connector 360 according to an embodiment.

Referring to FIGS. 9A and 9B, the first connector 310 according to an embodiment may include a first uneven area 338 and the second connector 360 may include a second uneven area 388.

Hereinafter, the description provided above is not repeated and it is obvious that a partial component or structure of the first connector 310, the second connector 360, and the electronic device 300 including a portion thereof may be replaced, added, or omitted within an understandable scope by one of ordinary skill in the art with reference to the following drawings and descriptions. In addition, unless it is obviously technically impossible, at least one component or feature of the embodiments described above may be coupled to the first connector 310, the second connector 360, and the electronic device 300 including a portion thereof.

In an embodiment, the first uneven area 338 may be provided at the first barrier 330 and may have an asymmetrical shape in a lateral direction (e.g., the X-axis direction or X-Z plane direction) based on a cross-section perpendicular to the first surface 313. The second uneven area 388 may be provided at the second barrier 380 and may have an uneven shape facing the first uneven area 338.

In an embodiment, as the first uneven area 338 and the second uneven area 388 face each other in asymmetrical shapes, reverse insertion of the first connector 310 and the second connector 360 may be prevented and an insertion direction may be guided.

For example, the first uneven area 338 may be a concave area in the first barrier 330 and the second uneven area 388 may be a convex area in the second barrier 380. Alternatively, the first uneven area 338 may be a convex area in the first barrier 330 and the second uneven area 388 may be a concave area in the second barrier 380.

In an embodiment, when the second connector 360 is reversely inserted into the first connector 310, an improper connection between the plurality of first terminals 320 and the plurality of second terminals 370 may occur. For example, the improper connection may occur as an anode power terminal of the plurality of first terminals 320 is connected to an anode power terminal of the plurality of second terminals 370.

In an embodiment, when the first connector 310 and the second connector 360 are coupled to each other, the first barrier 330 and the second barrier 380 may face each other. As the first barrier 330 and the second barrier 380 include the first uneven area 338 and the second uneven area 388 that are asymmetrical in the lateral direction to correspond to each other, respectively, the second connector 360 may be guided not to be coupled to the first connector 310 in the reverse insertion direction, the insertion direction of the first connector 310 and the second connector 360 may be guided, and coupling stability between the first connector 310 and the second connector 360 may be improved.

In an embodiment, when the first barrier 330 and the second barrier 380 are coupled to face each other while the first connector 310 and the second connector 360 are coupled to each other, the third barrier 340 and the fourth barrier 390 may be coupled to face each other and the coupling stability between the first connector 310 and the second connector 360 may be improved.

In an embodiment, even when the first barrier 330 and the second barrier 380 are not coupled to face each other, the third barrier 340 and the fourth barrier 390 may be coupled to face each other and the coupling stability between the first connector 310 and the second connector 360 may be provided.

In FIGS. 9A and 9B, the first uneven area 338 and the second uneven area 388 are formed in the first inner barrier 336 of the first barrier 330 and the second inner barrier 386 of the second barrier 380, respectively, but the actual implementation is not limited thereto.

For example, the first uneven area 338 and the second uneven area 388 may be formed in at least one of the first outer barrier 331 and the first inner barrier 336 of the first barrier 330 and at least one of the second outer barrier 381 and the second inner barrier 386 of the second barrier 380.

For example, the first uneven area 338 and the second uneven area 388 may be formed in the third barrier 340 and the fourth barrier 390, respectively.

For example, the shapes, sizes, and/or arrangements of the first uneven area 338 and the second uneven area 388 may be variously implemented to couple the first connector 310 and the second connector 360 to each other in a possible direction to face each other.

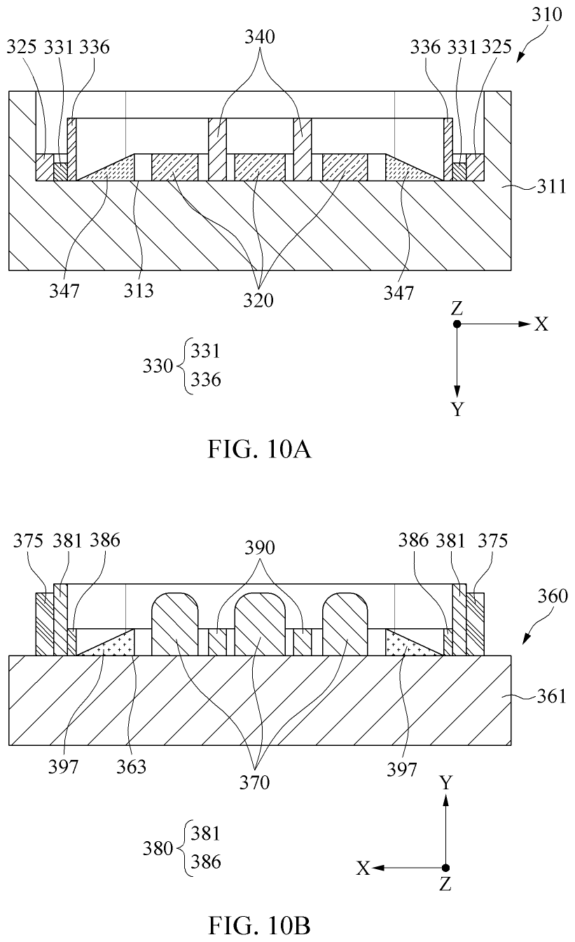

FIG. 10A is a cross-sectional view of the first connector 310 according to an embodiment and FIG. 10B is a cross-sectional view of the second connector 360 according to an embodiment.

Referring to FIGS. 10A and 10B, the first connector 310 according to an embodiment may include a first bottom member 347. In addition, the second connector 360 according to an embodiment may include a second bottom member 397.

Hereinafter, the description provided above is not repeated and it is obvious that a partial component or structure of the first connector 310, the second connector 360, and the electronic device 300 including a portion thereof may be replaced, added, or omitted within an understandable scope by one of ordinary skill in the art with reference to the following drawings and descriptions. In addition, unless it is obviously technically impossible, at least one component or feature of the embodiments described above may be coupled to the first connector 310, the second connector 360, and the electronic device 300 including a portion thereof.

In an embodiment, the first bottom member 347 may be formed on the first surface 313 in the first housing 311. The first bottom member 347 may be disposed between the plurality of first terminals 320 and the first barrier 330. The first bottom member 347 may be configured to gradually increase the height extending from the first surface 313 as the first bottom member 347 develops in a direction approaching the first barrier 330 from the plurality of first terminals 320.

In an embodiment, the first bottom member 347 may guide, in a direction away from the plurality of first terminals 320, a foreign substance entering the first connector 310. When a foreign substance enters near the plurality of first terminals 320, the plurality of first terminals 320 may collide with an external object, the foreign substance may be attached to the plurality of first terminals 320, or the plurality of first terminals 320 may be short-circuited or disconnected. The first bottom member 347 may reduce or prevent an inflow of a foreign substance between the plurality of first terminals 320 and may protect the plurality of first terminals 320.

In an embodiment, the first bottom member 347 may be formed by injection molding as one continuous body with the first housing 311 or may be formed by double-shot injection with the first housing 311. Alternatively, the first bottom member 347 may be molded separately from the first housing 311 and may be coupled to the first housing 311. Alternatively, the first bottom member 347 may be formed by injection molding as one continuous body with one of the first barrier 330 or the third barrier 340.

In an embodiment, the second bottom member 397 may be formed on the second surface 363 in the second housing 361. The second bottom member 397 may be disposed between the plurality of second terminals 370 and the second barrier 380. The second bottom member 397 may be configured to gradually increase the height extending from the second surface 363 as the second bottom member 397 develops in a direction approaching the second barrier 380 from the plurality of second terminals 370.

In an embodiment, the second bottom member 397 may guide, in a direction away from the plurality of second terminals 370, a foreign substance entering the second connector 360. When a foreign substance enters near the plurality of second terminals 370, the plurality of second terminals 370 may collide with an external object, the foreign substance may be attached to the plurality of second terminals 370, or the plurality of second terminals 370 may be short-circuited or disconnected. The second bottom member 397 may reduce or prevent an inflow of a foreign substance between the plurality of second terminals 370 and may protect the plurality of second terminals 370.

In an embodiment, the second bottom member 397 may be formed by injection molding as one continuous body with the second housing 361 or may be formed by double-shot injection with the second housing 361. Alternatively, the second bottom member 397 may be molded separately from the second housing 361 and may be coupled to the second housing 361. Alternatively, the second bottom member 397 may be formed by injection molding as one continuous body with one of the second barrier 380 or the fourth barrier 390.

The effects to be achieved are not limited to those described above, and other effects not mentioned above will be clearly understood by one of ordinary skill in the art from the following description.

The electronic device 300 according to an embodiment, may include the first connector 310 including the first housing 311 including the first surface 313, the plurality of first terminals 320 provided on the first surface 313, the first magnetic body 325 enclosing the plurality of first terminals 320, and the first barrier 330 enclosing an inner side surface of the first magnetic body 325, and the second connector 360 that is connectable to the first connector 310 and includes the second housing 361 including the second surface 363, the plurality of second terminals 370 provided on the second surface 363, the second magnetic body 375 attachable to and detachable from the first magnetic body 325 and enclosing the plurality of second terminals 370, and the second barrier 380 enclosing an inner side surface of the second magnetic body 375. In an embodiment, in at least a partial area, the first barrier 330 may extend higher than the first magnetic body 325 from the first surface 313. In an embodiment, in at least a partial area, the second barrier 380 may extend higher than the second magnetic body 375 from the second surface 363.

In an embodiment, the first barrier 330 may include the first outer barrier 331 in contact with the inner side surface of the first magnetic body 325 and extending lower than the first magnetic body 325 from the first surface 313, and the first inner barrier 336 in contact with an inner side surface of the first outer barrier 331 and extending higher than the first magnetic body 325 from the first surface 313.

In an embodiment, the second barrier 380 may include the second outer barrier 381 in contact with the inner side surface of the second magnetic body 375 and extending higher than the second magnetic body 375 from the second surface 363, and the second inner barrier 386 in contact with an inner side surface of the second outer barrier 381 and extending lower than the second magnetic body 375 from the second surface 363.

In an embodiment, the first magnetic body 325 may have a first width d1 based on a cross-section perpendicular to the first surface 313. In an embodiment, the first barrier 330 may have a second width d2 that is greater than the first width d1 based on a cross-section perpendicular to the first surface 313.

In an embodiment, the second magnetic body 375 may have a third width d3 based on a cross-section perpendicular to the second surface 363. In an embodiment, the second barrier 380 may have a fourth width d4 that is greater than the third width d3 based on the cross-section perpendicular to the second surface 363.

In an embodiment, the first connector 310 may further include a third barrier 340 disposed between two of the plurality of first terminals 320. In an embodiment, the second connector 360 may further include a fourth barrier 390 disposed between two of the plurality of second terminals 370.

In an embodiment, in at least a partial area, the third barrier 340 may extend higher than the plurality of first terminals 320 from the first surface 313. In an embodiment, in at least a partial area, the fourth barrier 390 may extend lower than the plurality of second terminals 370 from the second surface 363.

In an embodiment, the third barrier 340 may include the third outer barrier 341 extending higher than the plurality of first terminals 320 from the first surface 313, and the third inner barrier 346 in contact with an inner side surface of the third outer barrier 341 and extending lower than the plurality of first terminals 320 from the first surface 313.

In an embodiment, the fourth barrier 390 may include the fourth outer barrier 391 extending lower than the plurality of second terminals 370 from the second surface 363, and the fourth inner barrier 396 in contact with an inner side surface of the fourth outer barrier 391 and extending lower than the plurality of second terminals 370 from the second surface 363.

In an embodiment, the third barrier 340 may extend higher than the plurality of first terminals 320 from the first surface 313. In an embodiment, the fourth barrier 390 may extend higher than the plurality of second terminals 370 from the second surface 363. In an embodiment, the third barrier 340 and the fourth barrier 390 may be disposed adjacent to each other in a side direction based on a state in which the connector and the second connector 360 are connected to each other.

In an embodiment, the second connector 360 may further include the fifth barrier 398 enclosing an outer side surface of the second magnetic body 375 and in at least a partial area, extending lower than the second magnetic body 375 from the second surface 363.

In an embodiment, the second barrier 380 may have a fourth width d4 based on a cross-section perpendicular to the second surface 363. In an embodiment, the fifth barrier 398 may have a fifth width d5 that is less than the fourth width d4 based on the cross-section perpendicular to the second surface 363.

In an embodiment, the first barrier 330 may be configured to increase or decrease a height in a direction in which the first barrier 330 develops while enclosing the first magnetic body 325. In an embodiment, the second barrier 380 may be configured to gradually decrease or increase a height in a direction in which the second barrier 380 develops at a ratio corresponding to a height change of the first barrier 330 while enclosing the second magnetic body 375.

In an embodiment, the first barrier 330 may include a first uneven area 338 having an asymmetrical shape in a lateral direction based on the cross-section perpendicular to the first surface 313. In an embodiment, the second barrier 380 may include a second uneven area 388 having an uneven shape facing the first uneven area 338.

In an embodiment, the first connector 310 may include the first bottom member 347 disposed between the plurality of first terminals 320 and the first barrier 330 in the first surface 313. In an embodiment, the first bottom member 347 may be configured to decrease a height extending from the first surface 313 as the first bottom member 347 develops in a direction approaching the first barrier 330 from the plurality of first terminals 320.

In addition, the electronic device 300 according to an embodiment may include the first housing 311 including the first surface 313, the plurality of first terminals 320 provided on the first surface 313, the first magnetic body 325 enclosing the plurality of first terminals 320, and the first barrier 330 enclosing an inner side surface of the first magnetic body 325. In an embodiment, in at least a partial area, the first barrier 330 may extend higher than the first magnetic body 325 from the first surface 313.

In an embodiment, the first barrier 330 may include the first outer barrier 331 in contact with the inner side surface of the first magnetic body 325 and extending lower than the first magnetic body 325 from the first surface 313, and the first inner barrier 336 in contact with an inner side surface of the first outer barrier 331 and extending higher than the first magnetic body 325 from the first surface 313.

In an embodiment, the first magnetic body 325 may have a first width d1 based on a cross-section perpendicular to the first surface 313. In an embodiment, the first barrier 330 may have a second width d2 that is greater than the first width d1 based on a cross-section perpendicular to the first surface 313.

In an embodiment, the electronic device 300 may further include the third barrier 340 disposed between two of the plurality of first terminals 320.

In an embodiment, the third barrier 340 may extend higher than the plurality of first terminals 320 from the first surface 313 in at least a partial area.

Although desirable embodiments are illustrated and described above, the present disclosure is not limited to said certain embodiments, various applications may surely be performed by those skilled in the art without deviating from what is claimed in the scope of claims, and such applications should not be understood separately from the technical idea or prospects herein.

What is claimed is:

1. An electronic device comprising:
a first connector comprising a first housing comprising a first surface, a plurality of first terminals provided on the first surface, a first magnetic body enclosing the plurality of first terminals, and a first barrier enclosing an inner side surface of the first magnetic body; and
a second connector that is connectable to the first connector and comprises a second housing comprising a second surface, a plurality of second terminals provided on the second surface, a second magnetic body attachable to and detachable from the first magnetic body and enclosing the plurality of second terminals, and a second barrier enclosing an inner side surface of the second magnetic body,
wherein, in at least a partial area, the first barrier extends higher than the first magnetic body from the first surface, and
in at least a partial area, the second barrier extends higher than the second magnetic body from the second surface.

2. The electronic device of claim 1, wherein:
the first barrier comprises:
a first outer barrier in contact with the inner side surface of the first magnetic body and extending lower than the first magnetic body from the first surface; and
a first inner barrier in contact with an inner side surface of the first outer barrier and extending higher than the first magnetic body from the first surface, and
the second barrier comprises:
a second outer barrier in contact with the inner side surface of the second magnetic body and extending higher than the second magnetic body from the second surface; and
a second inner barrier in contact with an inner side surface of the second outer barrier and extending lower than the second magnetic body from the second surface.

3. The electronic device of claim 1, wherein:
the first magnetic body has a first width based on a cross-section perpendicular to the first surface, and
the first barrier has a second width that is greater than the first width based on a cross-section perpendicular to the first surface,
the second magnetic body has a third width based on a cross-section perpendicular to the second surface, and
the second barrier has a fourth width that is greater than the third width based on the cross-section perpendicular to the second surface.

4. The electronic device of claim 1, wherein:
the first connector further comprises a third barrier disposed between two of the plurality of first terminals,
the second connector further comprises a fourth barrier disposed between two of the plurality of second terminals,
in at least a partial area, the third barrier extends higher than the plurality of first terminals from the first surface, and
in at least a partial area, the fourth barrier extends lower than the plurality of second terminals from the second surface.

5. The electronic device of claim 4, wherein:
the third barrier comprises:
a third outer barrier extending higher than the plurality of first terminals from the first surface; and
a third inner barrier in contact with an inner side surface of the third outer barrier and extending lower than the plurality of first terminals from the first surface, and
the fourth barrier comprises:
a fourth outer barrier extending lower than the plurality of second terminals from the second surface; and
a fourth inner barrier in contact with an inner side surface of the fourth outer barrier and extending lower than the plurality of second terminals from the second surface.

6. The electronic device of claim 1, wherein:
the first connector further comprises a third barrier disposed between two of the plurality of first terminals,
the second connector further comprises a fourth barrier disposed between two of the plurality of second terminals,
the third barrier extends higher than the plurality of first terminals from the first surface,
the fourth barrier extends higher than the plurality of second terminals from the second surface, and
the third barrier and the fourth barrier are disposed adjacent to each other in a side direction based on a state in which the first connector and the second connector are connected to each other.

7. The electronic device of claim 1, wherein the second connector further comprises:
a fifth barrier enclosing an outer side surface of the second magnetic body and in at least a partial area, extending lower than the second magnetic body from the second surface,
wherein the second barrier has a fourth width based on a cross-section perpendicular to the second surface, and
the fifth barrier has a fifth width that is less than the fourth width based on the cross-section perpendicular to the second surface.

8. The electronic device of claim 1, wherein the first barrier is configured to increase or decrease a height in a direction in which the first barrier develops while enclosing the first magnetic body, and
the second barrier is configured to gradually decrease or increase a height in a direction in which the second barrier develops at a ratio corresponding to a height change of the first barrier while enclosing the second magnetic body.

9. The electronic device of claim 1, wherein the first barrier comprises a first uneven area having an asymmetrical shape in a lateral direction based on the cross-section perpendicular to the first surface, and
the second barrier comprises a second uneven area having an uneven shape facing the first uneven area.

10. The electronic device of claim 1, wherein the first connector comprises a first bottom member disposed between the plurality of first terminals and the first barrier in the first surface, and
the first bottom member is configured to decrease a height extending from the first surface as the first bottom member develops in a direction approaching the first barrier from the plurality of first terminals.

11. An electronic device comprising:
a first connector comprising a first surface, first terminals provided on the first surface, a first magnetic body enclosing the first terminals, and a first barrier enclosing an inner side of the first magnetic body; and
a second connector connectable to the first connector and comprising a second surface, second terminals provided on the second surface, a second magnetic body attachable to and detachable from the first magnetic body and enclosing the second terminals, and a second barrier enclosing an inner side of the second magnetic body,
wherein the first barrier extends higher than the first magnetic body from the first surface and the second barrier extends higher than the second magnetic body from the second surface.

12. The electronic device of claim 11, wherein:
the first barrier comprises:
a first outer barrier in contact with the inner side surface of the first magnetic body and extending lower than the first magnetic body from the first surface; and
a first inner barrier in contact with an inner side surface of the first outer barrier and extending higher than the first magnetic body from the first surface, and
the second barrier comprises:
a second outer barrier in contact with the inner side surface of the second magnetic body and extending higher than the second magnetic body from the second surface; and
a second inner barrier in contact with an inner side surface of the second outer barrier and extending lower than the second magnetic body from the second surface.

13. The electronic device of claim 11, wherein:
the first magnetic body has a first width based on a cross-section perpendicular to the first surface, and
the first barrier has a second width that is greater than the first width based on a cross-section perpendicular to the first surface,
the second magnetic body has a third width based on a cross-section perpendicular to the second surface, and
the second barrier has a fourth width that is greater than the third width based on the cross-section perpendicular to the second surface.

14. The electronic device of claim 11, wherein:
the first connector further comprises a third barrier disposed between two of the plurality of first terminals,
the second connector further comprises a fourth barrier disposed between two of the plurality of second terminals,
in at least a partial area, the third barrier extends higher than the plurality of first terminals from the first surface, and
in at least a partial area, the fourth barrier extends lower than the plurality of second terminals from the second surface.

15. The electronic device of claim 14, wherein:
the third barrier comprises:
a third outer barrier extending higher than the plurality of first terminals from the first surface; and
a third inner barrier in contact with an inner side surface of the third outer barrier and extending lower than the plurality of first terminals from the first surface, and
the fourth barrier comprises:
a fourth outer barrier extending lower than the plurality of second terminals from the second surface; and
a fourth inner barrier in contact with an inner side surface of the fourth outer barrier and extending lower than the plurality of second terminals from the second surface.

16. The electronic device of claim 11, wherein:
the first connector further comprises a third barrier disposed between two of the plurality of first terminals,
the second connector further comprises a fourth barrier disposed between two of the plurality of second terminals,
the third barrier extends higher than the plurality of first terminals from the first surface,
the fourth barrier extends higher than the plurality of second terminals from the second surface, and
the third barrier and the fourth barrier are disposed adjacent to each other in a side direction based on a state in which the first connector and the second connector are connected to each other.

17. The electronic device of claim 11, wherein the second connector further comprises:
a fifth barrier enclosing an outer side surface of the second magnetic body and in at least a partial area, extending lower than the second magnetic body from the second surface,
wherein the second barrier has a fourth width based on a cross-section perpendicular to the second surface, and
the fifth barrier has a fifth width that is less than the fourth width based on the cross-section perpendicular to the second surface.

18. The electronic device of claim 11, wherein the first barrier is configured to increase or decrease a height in a direction in which the first barrier develops while enclosing the first magnetic body, and
the second barrier is configured to gradually decrease or increase a height in a direction in which the second barrier develops at a ratio corresponding to a height change of the first barrier while enclosing the second magnetic body.

19. The electronic device of claim 11, wherein the first barrier comprises a first uneven area having an asymmetrical shape in a lateral direction based on the cross-section perpendicular to the first surface, and
the second barrier comprises a second uneven area having an uneven shape facing the first uneven area.

20. The electronic device of claim 11, wherein the first connector comprises a first bottom member disposed between the plurality of first terminals and the first barrier in the first surface, and
the first bottom member is configured to decrease a height extending from the first surface as the first bottom member develops in a direction approaching the first barrier from the plurality of first terminals

21. An electronic device comprising:
a first housing comprising a first surface;
a plurality of first terminals provided on the first surface;
a first magnetic body enclosing the plurality of first terminals; and
a first barrier enclosing an inner side surface of the first magnetic body,
wherein, in at least a partial area, the first barrier extends higher than the first magnetic body from the first surface.

22. The electronic device of claim 21, wherein the first barrier comprises:
a first outer barrier in contact with the inner side surface of the first magnetic body and extending lower than the first magnetic body from the first surface; and
a first inner barrier in contact with an inner side surface of the first outer barrier and extending higher than the first magnetic body from the first surface.

23. The electronic device of claim 21, wherein the first magnetic body has a first width based on a cross-section perpendicular to the first surface, and
the first barrier has a second width that is greater than the first width based on a cross-section perpendicular to the first surface.

24. The electronic device of claim 21, further comprising:
a third barrier disposed between two of the plurality of first terminals,
wherein the third barrier extends higher than the plurality of first terminals from the first surface in at least a partial area.
